(19) United States
(12) Patent Application Publication
(10) Pub. No.: US 2007/0191983 A1
(43) Pub. Date: Aug. 16, 2007

(54) Automated wine cellar

(76) Inventors: John Philip Griffits, Tallai (AU); Yvonne Sylvia Griffits, Tallai (AU)

Correspondence Address: JOHN PHILIP GRIFFITS, 99A TALLAI RD., TALLAI, 4213, AU

(21) Appl. No.: 10/598,833

(22) PCT Filed: Mar. 16, 2005
(86) PCT No.: PCT/AU05/00375

§ 371 Date: Sep. 13, 2006

(30) Foreign Application Priority Data
Mar. 16, 2004 (AU) 2004901351

(51) Int. Cl. G06F 7/00; G05B 19/00

(52) U.S. Cl. 700/213; 340/5.92

(57) ABSTRACT

An electrically operate system that facilitate human interaction with food and beverage containers and their contents. Electrically operable indicators (eg LED's) facilitate human insertion/retrieval of wine bottles to/from wine storage systems (eg wine cellar, wine rack). A similar system permits beverages used in the preparation of mixed drinks (eg cocktails) to be readily located by a human. An electronic system facilitate the addition of predetermined amounts of beverages to a cocktail or similar mix. An electrically operable display attached to a drinking container (eg cocktail glass) is disclosed that presents details pertaining to the person intended to consume the cocktail and/or information about the cocktail. A method of providing a box of chocolates with a display that may be used to output an electronic greeting card and/or facilitate selection of a first chocolate from a second chocolate is disclosed. The system may be used to locate beverage and/or food items in a store (eg supermarket, liquor outlet).

### INTRODUCTION

The present invention describes electrically operable systems for application with food and/or beverage containers that preferably contain food and/or beverage. It has particular application to the placement, rearrangement and retrieval of wine containers stored, in and/or on and/or otherwise coupled to, a storage apparatus (eg in a commercial cellar, domestic cellar, wine rack, shelves and/or other container storage device in a retail outlet, restaurant, bar). The invention is preferably not limited to containers of wine.

The present specification discloses a method and apparatus that preferably utilises part at least of the means described for application with bottles of wine, to locate one or more containers of beverage items used in the preparation of mixed beverages—eg alcoholic cocktails. The cocktail preparation system, for example, preferably facilitates one at least persons (eg bar person, householder) to locate the required mixed beverage ingredients using automated means (eg a LED coupled to the desired beverage container, illuminating to indicate that said coupled container is the target container). The cocktail preparation system is preferably coupled to information stored on computer readable media, said information preferably including information pertaining to the preparation of one or more mixed beverages (eg cocktails). The invention preferably provides for an electrically operable device to facilitate a person adding a predetermined amount of at least a first beverage, to a beverage container (eg cocktail glass).

The invention preferably includes a system for providing beverage containers (eg. glasses, mugs, cups) used to consume beverages with electrically generated information pertaining to, for example, the consumer of said beverage and/or information pertaining to said beverage. This is preferably achieved by coupling one at least electrically operable displays to said beverage container. Said display preferably may present other information. Said display is preferably coupled to a secure processing device and/or secure computer memory. For example, said secure device may accept the placement of bets and/or store electronic funds.

A system is disclosed for selecting one or more particular chocolates from a selection of different chocolate stored in a container (eg. chocolate box), preferably using part at least of the electrically operable means described for selecting one at least containers of wine and/or beverage ingredients for a mixed beverage. A system is disclosed for providing a container for chocolates with an electrically operable display.

The invention preferably allows for use of part at least of the disclosures in this specification with known art beverage and/or food containers, for example, the system may be applied to permit a customer to locate one at least containers of beverage from a plurality of beverage containers stored on one or more shelves in a shop (eg shop selling wines and spirits) and/or one at least containers of food stored on a supermarket shelf.

Definitions.

The use of one at least examples (or abbreviations for same) should be understood as meaning ‘one at least non-limiting example(s)’ The use of one at least examples in this specification preferably does not necessarily imply that said examples are essential to the invention, and/or preferably that said one at least examples (unless otherwise documented) are the preferred means. Furthermore when a plurality of examples are described it should be understood that in preferably one at least embodiment, none of said plurality may be used; and/or that in one at least embodiment preferably one at least of said plurality may and/or may not be used. It should also be understood that the use of the singular of a word and/or phrase preferably may also be understood to reference the plural; and use of the plural preferably may be understood to reference the singular, where appropriate in the context used.

The invention preferably allows that part at least of the means described for a first means of the invention may be performed, in part at least, by one at least other means described for the invention and/or one at least other means.

Beverage Container is preferably any container suitable for storing a beverage. For example a glass bottle, plastic bottle, carton, glass, cup, mug, cocktail shaker. It is preferable that the use of the term ‘beverage container’ may be understood as applying to one at least of the following non-limiting examples:—a beverage container filled with one at least beverages, a beverage container partially filled with one at least beverages, an empty beverage container that has previously stored a beverage, an empty beverage container that is able to be subsequently filled in part at least, with one at least beverages, a partially filled beverage container able to be subsequently filled with additional beverage.

To facilitate understanding of the present invention the following terminology may be used to differentiate beverage containers by function:—

Beverage Drinking Container (also referenced as BDC)—is preferably applicable to a container used by a person to consume beverage, for example glass, mug, cup. It is preferable that a bottle (eg bottle of wine) that a person drinks directly from is an example of a beverage drinking container.

Beverage Storage Container (also referenced as BSC) is preferably applicable to a container used to store beverage for future use. Examples of said use include consumption, mixing with another beverage prior to consumption. A non-limiting example of said future including at least a day after placing said beverage in said container. Examples of said BSC preferably include:—a) bottle of wine (eg laid down in a cellar for future use, on the table pending pouring into a BDC), b) bottle storing a beverage used in the preparation of a cocktail.

Beverage Mixing Container (also referenced as BMC) is preferably applicable to a container used to receive a first beverage at a first instant and a second beverage at a second to produce a mixed and/or compounded beverage formed from said first and second beverages. Examples of said BMC preferably include a) Cocktail Shaker, b) glass, c) bottle.

It is preferable that one at least beverage containers is not functionally limited. For example:—a) a person may drink directly from a cocktail shaker in which case it preferably may be a BDC and/or BMC; b) a person may mix a cocktail in a glass and may also drink said cocktail from said glass, in which case said glass is preferably a BMC and BDC or they may transfer the cocktail to another glass, in which case said glass is preferably a BMC; c) a partly filled bottle of beverage that has acted as a BSC may have another beverage added, in which case said BSC is also preferably a BMC.

It is preferable that one at least beverage containers are comprised in part at least of edible material, for example chocolate.

It is preferable that the term beverage may be replaced with the term food. It is preferable that the term beverage container may be replaced with food container.

### Description

The first part of the invention discloses a method and apparatus to automate the preparation of beverages, in particular mixed beverages.

The invention preferably allows for an electrically operable device that facilitates the preparation of a first beverage in a first and/or second beverage container. Said device is coupled to information stored in and/or on computer readable media. Said beverage is comprised of a plurality of ingredients, that preferably include a plurality of different beverages. For example, a first ingredient is preferably added to said container and a second ingredient is subsequently added to the first ingredient in said container. Said beverage includes an alcoholic beverage. The electrically operable beverage preparation facilitator preferably facilitates preparation of a second beverage in a beverage container, said container preferably being said first beverage container and/or a second beverage container. It is preferable that said second beverage may be a beverage prepared after part at least of said first beverage has been removed from said container. It is preferable that said second beverage is comprised of:—
a) one at least beverage ingredients that is distinct by the type of beverage when compared to the beverage ingredients of said first beverage; and/or
b) one at least beverage ingredients that is distinct by the amount of beverage when compared to the beverage ingredients of said first beverage.

It is preferable that said computer accesible information includes information pertaining to part at least of the type of ingredients of one at least mixed beverages. Said type preferably includes information to facilitate identification of one at least ingredient beverages. Examples of said beverage ingredients preferably include beverage one at least of Whisky, Scotch, Gin, Vodka, Rum, Brandy, Blue Curacao, Green Curacao, Advocaat, Creme de Menthe, Schnapps, Sake, Grand Marnier, Kahlua, Benedictine, Calasay. Said information preferably facilitates user identification of one at least particular brands of said ingredients. Said information preferably facilitates the output of information pertaining to said beverage ingredient on an electrically operable display. The displayed information preferably includes text information pertaining to the name of said beverage and/or the brand of said beverage.

The displayed information preferably includes text and/or image information pertaining to one at least indicia and/or coloured areas attached to the beverage storage container used to store said beverage ingredient prior to adding said beverage to said first and/or second beverage container.

The displayed information preferably includes one at least areas of one at least colours, and/or descriptive information identifying one at least colours, said colours equating to one at least coloured areas attached to said beverage container. The displayed indicia and/or coloured areas preferably equate to visible indicia and/or colours on an apparatus attached to and/or attachable to said beverage storage container. Said apparatus preferably may be attached to said beverage storage container after sale of said beverage storage container and contents. The apparatus preferably reversibly attaches to said beverage storage container. The apparatus preferably includes the name of the type and/or brand of the beverage in said beverage storage container. The apparatus preferably includes a hole permitting said apparatus to fit over the neck of a beverage storage container that is a bottle.

The displayed information preferably includes image information pertaining to the container of said beverage ingredient. For example, an image of a label on said beverage container.

It is preferable that part at least of the displayed information (for part at least of the display means described in this specification) may be provided as electrically generated voice instead of and/or in addition to said displayed information.

It is preferable that said information coupled to said beverage facilitation device includes digital content pertaining to an electronically addressable device associated with one at least beverage storage containers storing one at least beverages prior to addition to said first and/or second beverage container. The digital content preferably may be used to address and/or facilitate addressing one at least electrically operable indicators attached to one at least beverage storage containers. The digital content preferably may used to address and/or facilitate addressing one at least electrically operable indicators attached to a storage system for beverage storage containers. Said indicator is preferably visibly associated with said beverage storage container. Said addressing preferably includes the wireless transfer of information. Said addressing preferably facilitates the automated change of state of said indicator. Said change of state preferably advises a person that said associated beverage container stores an ingredient in said beverage mix. The advised ingredient of said beverage mix is preferably the next ingredient to be added. Said change of state preferably includes one at least electrically operable light producing devices illuminating in one at least colours and/or changing flash rates, and/or changing intensity.

The information of said computer readable media preferably includes information pertaining to the availability of one at least required beverage ingredients for a beverage mix. The availability information is preferably obtained by reading an electrically operable device attached to one at least beverage storage containers. Said read preferably may be by an electronic device attached to said electrically operable beverage preparation facilitator. The reading preferably may include the reversible contact of electrical conductors. The reading preferably may include wireless. For example, the use of an RFID Transponder and RFID reader. The availability information preferably may be obtained by an apparatus discrete to said electrically operable beverage preparation facilitator. Said availability information is preferably transferred to said beverage preparation facilitator by wired and/or wireless transfer.

The information of said computer readable media preferably includes information pertaining to the amount of one at least ingredients to add to one at least mixed beverages. Said amount preferably includes volume information. Said information preferably includes mass and/or weight information. Said amount preferably includes information pertaining to a level in said beverage container and/or apparatus associated with said beverage container. The level information used is preferably variable depending on the sequence that said ingredient is added to said container, for example a beverage container that includes a non-vertical side and/or has a formed shape in part of the internal surface of said container. The level information used is preferably variable depending on the diameter of said container, for example where the diameter varies from a first to second beverage container, and from a first level in said beverage container to a second level in the same beverage container.

The information on said computer readable media preferably includes information pertaining to the amount of alcohol in one at least beverages.

Said computer readable media preferably include semiconductor memory. Said memory preferably may be written to. Said memory is preferably non-volatile, for example flash memory. Said computer media preferably includes one at least of optical media. magnetic media, heat programmable polymer.

The electrically operable beverage preparation facilitator is preferably usable by one at least person, wherein the amount of one at least ingredients added to said first and or second beverage container is determined in part at least by a human, and said human determination is facilitated by visual and/or audible information provided by said beverage preparation facilitator. Said added preferably includes transferring said beverage into said beverage container from a beverage storage container. It is preferable that said transfer may include a person manually manipulating said beverage storage container from a first position, in which said beverage is retained by gravity in said beverage storage container, to a second position in which part at least of said beverage is caused to move under the influence of gravity from said beverage storage container into said beverage container. It is preferable that said transfer may include the use of a beverage storage container that is attached to a flow control device that in a first state obstructs the flow of beverage from said container and in a second state permits the flow of beverage from said container, and said container is positioned such that beverage flows from said container under the influence of gravity when said device is in said second state. It is preferable said change of state may be manual and/or include the use of electrically operable means. It is preferable that said change of state is facilitated by a manual process (eg a human pushing a button, switch, voice command, displayed menu selection). Said transfer preferably may include the use of a beverage storage container attached to a pump that facilitates flow of beverage from said beverage storage container to said beverage container. Said pump preferably may be manually and/or electrically operable. said electrically operable preferably may include in response to manual and/or automated processes.

The electrically operable beverage preparation facilitator wherein one at least beverages is added to said beverage container by a means that:—
a) automatically determines which beverage storage container to source beverage from, and
b) automates the flow of said beverage into said beverage container.

The electrically operable beverage preparation facilitator is described later in this document in extended detail with reference to the drawing as is a beverage container with an attached electronic display.

The invention preferably applies to beverages and food stored in containers prior to consumption. These containers may need to be handled and/or otherwise accessed by one at least persons after initial loading of the contents (eg by a manufacturer) into said container and prior to consumption of said contents. In some cases said containers (eg bottles and/or other containers of wine) may be stored for extended periods of time (eg, months, years, decades) and human facilitated processes may need to be applied to said containers (eg rotating a bottle of wine, resorting the storage locations of one or more bottles of wine to group particular types and/or vintages, finding a bottle of wine from a plurality of bottles).
a) It is a non-limiting preferred objective of the present invention to provide an electrically operable system of facilitating the placement of food and/or beverage containers into/onto storage locations.
b) It is a non-limiting preferred objective of the present invention to provide an electrically operable system to facilitate human understanding of information pertaining to the contents of one at least beverage containers, preferably without the need to physically examine said beverage container.
c) It is a non-limiting objective of the present invention to provide an electrically operable system to facilitate one at least human operations pertaining to said beverage container prior to consumption of the contents of said container.
d) It is a non-limiting preferred objective of the present invention to provide an electrically operable system to facilitate the selection and/or location of one at least stored beverage containers.

Wine is a popular beverage in many parts of the world and there is frequently a need to store a plurality of bottles of wine. As non-limiting examples, this may include:—
In a domestic environment—eg the domestic cellar and/or domestic bar.
A restaurant inventory of a quantity and/or variety of wines for their patrons.
A retail liquor outlet displaying wine for sale.
Wine producers who may need to store quantities and/or varieties of their wines.

One storage approach is to provide a Container Storage Means (eg. wine rack) for the wine bottles. It is preferable that said Container Storage Means is composed of a plurality of Container Receptacle Means (eg the voids in said wine rack), with the preferred arrangement allowing for each receptacle means to store one bottle of wine at a time. This invention seeks to describe an improved container storage means for bottles of wine, and in particular and preferably non-limiting, an automated means to assist the placement and/or retrieval of bottles of wine from said container storage means. The invention also describes improvements to container storage means that preferably may be used with or without the automated means described for the invention.

In this specification the term Container Receptacle Means is preferably applied to a void and/or opening that is capable of storing at least one bottle of wine. A group of Container Receptacle Means is referenced as a Container Storage Means.
The invention is preferably not limited to Container Receptacle Means that may only store one bottle of wine at a time.
The invention preferably allows that at any particular point of time one at least Container Storage Means may be fully populated, and/or partly populated, and/or unpopulated with wine bottles.
It is preferable that the invention is not limited by the number of Container Receptacle Means coupled to one at least Container Storage Means.
It is preferable that the invention is not limited by any variations in the diameter, and/or length, and/or volume, and/or arrangement, and/or any other characteristics of one at least Container Receptacle Means compared to one at least other Container Receptacle Means.

Modular Expansion of Container Storage Means.

As wine collections may grow, it is preferable that said Container Storage Means (CSM) may be expanded. This is preferably accomplished by the addition of extra Container Receptacle Means. It is preferable that said expansion is in a modular manner and when the module includes one at least Container Receptacle Means, said module may be referenced as a Module Receptacle Means.

It is a preferred non-limiting objective of the present invention to describe a means to facilitate the expansion of a Container Storage Means. This may be referenced as Container Storage Expansion Means or CSEM. It is preferable that said CSEM includes and/or is coupled to one at least of the following means:—
Electronic Interconnect Means to facilitate:—electrical and/or optical links, and/or digital, and/or analogue links, between plural modules in a Container Storage Means and/or other means coupled to said Container Storage Means.
Base Stabilisation Means to facilitate physical linkage of part at least of said CSM with a stable base (eg the ground, and/or floor, and/or shelf means).
Vertical Interconnect Means to facilitate linkage of one at least modules with one at least modules positioned in part at least, vertically above it.
Horizontal Interconnect Means to facilitate linkage of one at least modules with one at least modules positioned in part at least, to the right and/or left and/or front and/or back of it.
Vertical Stabilisation Means to facilitate linkage of one at least modules to a stable vertical (or approximately vertical) surface (eg a wall).

Decorative Facades.

There may be a requirement to decorate one or more surfaces of one at least Container Storage Means. It is preferable that this may be done at any time, preferably including after installation of said CSM. Said surfaces preferably may include the internal walls of one at least container receptacle means. A preferable non-limiting objective of the present invention seeks to describe a Facade Coupling Means to facilitate the coupling of one at least facades to one at least CSM's (in part at least). Said coupling is preferably secure. Non-limiting examples of materials forming component parts of said facade may include one at least of:—
Stone (eg jade, and/or marble, and/or granite, and/or onyx);
Timber;
Metals (eg Gold, Silver, Copper, Tin, Pewter, Platinum);
Plastics;
Fabrics (eg felt, and/or velvet, and/or satin, and/or silk);
Precious and/or semiprecious stones (eg diamonds, and/or rubies, and/or sapphires, and/or pearls, and/or opals, and/or emeralds);
Paint and/or ink
It is preferable that said Facade Means may be functional in part at least. As a non-limiting example, said Facade Means may open and close in one at least areas, preferably acting as one at least door means. Said facade preferably may include lock means. Said facade preferably may include latch and/or lock means.
It is preferable that there is a Facade Release Means to facilitate removal of said facade (in part at least).

Container Storage Control Means.

It is preferable that one at least Container Storage Means may be coupled to a data processing and/or data storage means, referenced in this document as the Container Storage Control Means (CSCM). Non-limiting examples of said data processing means may include, in part at least, personal computers and/or handheld computers (eg, Palm Computer), and/or microprocessor means. The Key Control Means of pending PCT AU 03/01029, Titled: “Identification and selection of keys for use with locks”, by the present inventors (incorporated by way of reference into this specification) preferably may be adapted to provide part at least of the functions of one at least CSCM and/or other electricaly operable devices described for the invention.
Said Container Storage Control Means preferably includes an electronic means.
   Said electronic means preferably includes computer readable and/or writeable media.
      Said media preferably includes DRAM, and/or SRAM, and/or ROM, and/or Flash Memory, and/or EEPROM, and or magnetic disk means (eg, floppy disk, and/or hard disk, and/or removable hard disk), and/or optical disk means (eg CD ROM and/or DVD). Said media preferably stores one at least computer programs and/or information that facilitates one at least computers implementing and/or facilitating one at least functions described for the present invention.
Said Container Storage Control Means preferably includes an operating system.
Said Container Storage Control Means preferably includes a non-volatile real time clock/calendar.
Said Container Storage Control Means preferably includes display means (eg CRT, LCD); and/or audio input means; and/or audio output means; and/or keyboard input means; and/or mouse means.
Said CSCM preferably communicates (preferably bidirectionally) with electronic means, and/or optical means, and/or wireless means coupled (preferably physically) with one at least parts of said CSM.
   Said electronic means preferably includes one at least microprocessors and/or integrated circuits.

It is preferable that said Container Storage Control Means adapts and/or may be adapted to accommodate the coupling of additional CRM's to the CSM.

Said Container Storage Control Means is preferably coupled to a Container Information Library.
Said library is preferably stored in electronic format.
Said library is preferably arranged as an electronic database.
Said library preferably includes information for one at least bottles of wine presently stored within said CSM.
Said library preferably includes information for one at least bottles of wine not presently stored within said CSM.
Said library preferably stores information pertaining to an extended variety of wines, from a comprehensive number of producers in a plurality of countries.

Said Container Information Library preferably includes information pertaining to one at least bottles of wine. Said information preferably includes one at least of the following non-limiting examples:—
Type of beverage, eg wine.
Subtype of beverage, eg red or white.
Variety of wine, eg chardonnay, moselle.
Vintage, eg. 1995.
Producer, eg Brown Brothers.
Location of winery, eg Hunter Valley, NSW, Australia.
Barcode on the container.
Information about the producer, that preferably includes text and or audio and/or imagery.
Information about the vintage, that preferably includes text and/or audio and/or imagery.
Information about wine in general.
Bottle length.
Bottle diameter.
Bottle Shape.
Bottle Volume.
Alcohol contents.
Volume of contents.
Log of the times/dates bottle inserted and/or removed from one at least Container receptacle means (CRM).
Log of the temperature in one at least CRM.
The cost and/or present value and/or future value of the bottle of wine within one at least RCM.
Log of the times/dates bottle rotated inside one at least CRM.
Reference to cocktails that may include the beverage in one at least CRM.
The electronic address of the indicator means coupled to the CRM storing the relevant bottle.
Digitised voice inputs that may be associated with various commands—in particular those that relate to information stored in said Container Information Library. For example, in addition (preferably) to storing the name of the Producer (eg Brown Brothers) in ASCII format, it preferably may also store one at least digitised voice inputs of the words ‘Brown Brothers’.
It is preferable that said CSCM is coupled to a Container Information Edit Means.
   It is preferable that part at least of said Container Information is supplied and/or updated by information from a remote location. Non-limiting examples of said remotely supplied information preferably may include by the Internet and/or other wide area network; and/or portable electronic storage means (eg CD ROM, and/or DVD, and/or Flash Card).
      It is preferable that users of the invention are periodically provided (eg quarterly and/or monthly) updated information on Optical Media (eg. CD and/or DVD) for installation on said CSCM.
   It is preferable that part at least of said container information may be supplied and/or updated by local means eg by the householder.
      As non-limiting examples it is preferable that local input means may include one at least of:—
         keyboard and/or mouse entry;
         image capture means (eg bar code scanning);
         voice input.

It is preferable that the Container Storage Control Means (CSCM) is coupled to a Module Spatial Arrangement Means (MSAM) to facilitate the automated determination of the spatial arrangement of one at least Module Receptacle Means (MRM) and/or Container Receptacle Means (CRM), with one at least other MRM and/or CRM. The actual spatial arrangement is preferably stored in electronic format as a Spatial Receptacle Library (SRL). It is preferable that said library stores the position of one at least CRM relative to a reference means.
A non-limiting example of said reference means may be a co-ordinate system with the origin located at the CRM at the bottom left hand-side of the CSM.
It is preferable that CRM spatial information may be updated.

It is preferable there is a Receptacle Constraints Library (RCL). Said RCL is preferably stored as part of said Spatial Receptacle Library. It is preferable that said constraints may nominate particular characteristics for wine and/or its bottle that need to be met and/or not met for it to be allocated storage in the relevant receptacle means and/or groups of receptacle means.
It is preferable that said constraints may be allocated and/or edited by appropriate inputs to said CSCM.
   As a non-limiting example, my lovely wife Yvonne is partial to Moselle and being of a gently petite build, she might like to locate these types of wine in receptacles within easy reach.
   As another non-limiting example, wines of a certain vintage and/or type may be kept for long term storage and allocated to less accessible receptacle means.
   As a non-limiting example, it is preferable that one at least of the parameters stored in the Container Information Library (see later in this specification) may be used as parameters in the constraints information.
   It is preferable that said constraints may be absolute and/or relative. Said relative may depend upon available resources.
It is preferable that one at least CSCM tracks the actual usage of product and preferably includes a learning means, preferably software based, that dynamically modifies one at least constraints to optimise the patterns and/or locations of insertion and/or removal of wine from one at least CSM.
It is preferable that constraints may be applied to bottles of wine that are about to be and/or are already stored within one at least CRM.
   It is preferable that this includes Bottle Usage Constraints (BUC'S) that preferably limit removal of one at least bottles from the CSM before a certain date.
      As a non-limiting example, it is preferable one may load the CSM with six bottles of a 1995 red wine, and specify that three of them are not to be used for another 3 years and the balance are to be kept for six years.
   It is preferable that this includes Bottle Rotation Constraints, that preferably specify when one at least stored bottles should be rotated in its CRM.
   As non-limiting examples, it is preferable that said constraints may be added at the time of bottle insertion and/or at a later date (eg. by using the editing features of the CRGRM—refer to the next section).

It is preferable there is a Receptacle Information Library (RIL). Said RIL is preferably stored as part of the Spatial Receptacle Library (SRL). Non limiting examples of information stored in said RIL preferably may include one at least of the following:—
Diameter of one at least receptacle means.
Depth of one at least receptacle means.
Geometric Shape of one at least receptacle means.
Direct and/or indirect electronic address of one at least receptacle means and/or means coupled to said receptacle means. Non-limiting examples of said coupled means may include:—
   Indicator means
   Receptacle Vacancy Detection Means
   Receptacle Temperature Detection Means.
   Receptacle Door-Lock Means.
   Receptacle Cooling Means.
It is preferable that part at least of said RIL may be created automatically, in part at least, from electronic means coupled to said CSM. It is further preferable that said electronic means are coupled to one at least Module Receptacle Means.

It is preferable that said Container Storage Control Means (CSCM) is coupled to a Container Receptacle Graphical Representation Means (CRGRM) that uses said SRL to produce a graphical representation of the spatial relationships of one at least CRM and/or MRM on a visual output means (eg CRT, LCD). Said graphical representation is referenced in this document as a Container Graphics Array (CGA).
It is preferable that as non-limiting examples, one at least parameters from the Receptacle Constraints Library and/or Receptacle Information Library and/or Container Information Library and/or User Input Information may be displayed on said Container Graphics Array.
It is preferable that said CGA distinguishes receptacles that are vacant from those that are occupied.
It is preferable that the CGA may display parameters pertaining to the actual wine stored in one at least receptacle means.
The preferred method of activating a graphical representation of a CRM for further action (eg. editing) is to place the mouse pointer over the relevant location and to click the mouse once at least, to bring up a menu that preferably allows other functions to be selected.
It is preferable that information pertaining to a particular receptacle means is displayed in a means that clearly associates it with said receptacle (eg displaying the information within a graphical representation of the receptacle means, and/or a visual link (eg line) between the information and the graphical representation of the CRM).
The preferred method is to use different colours and/or tones to define particular parameters. This is preferably augmented by text and/or graphics symbols.

Detecting Available Storage Locations in the Container Storage Means.

It is preferable that when a CSM is initially delivered and installed it has its CRM's empty. For the CSM to become operational it preferably may need to be stocked with at least one bottle of wine—preferably many bottles. During the course of normal operation, it is to be expected that a variable number of bottles will be removed and/or inserted over time. It is preferable that the Container Storage Control Means has access to current information with regard to the vacancy and/or occupancy of one at least CRM's—preferably all of them.
A preferred non-limiting objective of the present invention seeks to describe an automated Container Occupancy Detection Means to determine if one at least bottles of wine is presently occupying one at least Container Receptacle Means (CRM) in said Container Storage Means. This may be referenced as the Empty Receptacle Determination Means or ERDM if empty positions are monitored and/or Occupied Receptacle Determination Means or ORDM if occupied positions are monitored.
It is preferable that said Container Occupancy Detection Means may log the time and/or date that insertions and/or removal of bottles take place.
It is preferable that one at least CRM and preferably all, have a means to detect the presence or absence of a bottle. Said detection means preferably may signal its status by conductive and/or optical and/or wireless means to one at least data processing means. Non-limiting examples of said Bottle Detection Means preferably include one at least of:—
   Mechanical switch means.
   Opto-electronic means.
   RFID tag coupled to one at least containers (eg wine bottles) in one at least CRM; as a non-limiting example one at least containers preferably may have said RFID tag coupled (preferably reversibly) to the base of said bottle, and one at least CRM preferably includes one at least RFID Reader Means (eg at the back of one at least CRM), to read and/or write one at least RFID tag, the absence of said tag preferably indicating an empty CRM.
   Electronically readable tag coupled to one at least containers (eg wine bottles); eg Onewire ID tag from Dallas Semiconductors attached to the neck of one at least said containers, and preferably coupled to one at least CRM by a reversible electrical connection (eg plug/socket means) when stored in said CRM, the absence of ID tag preferably indicating an empty CRM.

Insertion of Bottles of Wine in a CSM.

A preferred non-limiting objective of the present invention seeks to describe an automated means to facilitate the insertion (in particular and as a non-limiting example, insertion by a human) of one at least bottles of wine into one at least Container Receptacle Means. This may be referenced as the Receptacle Stocking Facilitation Means or RSFM.
It is preferable that there is an Insertion Initialisation Means to communicate to the Container Storage Control Means (CSCM) that there is a requirement to load one at least bottles of wine into one at least CRM. The preferred means of said communication preferably include one at least of the following non-limiting examples:—
   Voice commands:—
      As a non-limiting example, a microphone input means that may be coupled to said CSCM by wireless and/or wired means may have the following phrase spoken into it:—‘Please load ‘x’ bottles of wine’ (‘x’ preferably represents a positive integer).
         It is preferable the sound input is digitised and forwarded to a voice recognition means (preferably coupled to the CSCM).
      Another non-limiting example voice input may be ‘Please load bottles’.
         It is preferable that means coupled to the CSCM may be able to automatically determine how many bottles are to be inserted.
   Keyboard commands.
   Mouse commands.
   Touch screen commands.
   Image capture means eg. bar code scanning.
It is preferable that plural communication means may be available—preferably concurrently.
It is preferable that there is a Product ID Means to communicate to the CSCM, information about the bottle(s) of wine to be inserted.
   Barcode Input Means:—As a non-limiting example, it is preferable that the Barcode coupled to one at least wine bottles may be used, in part at least, as the Product ID Means.
      It is preferable that said Barcode is already stored in an electronic means coupled to the CSCM—eg the Container Information Library.
         It is preferable that when a Barcode on said bottle for insertion is scanned (or otherwise input) that said CSCM checks any stored libraries of existing Barcodes.
         If said Barcode exists it is preferable that the CSCM verifies that there is sufficient additional information stored and coupled to the Barcode to facilitate removal of said bottle for insertion at a later time. If insufficient information is present it is preferably obtained using the Product Information Update Means (see below). If said Barcode is not present, it is preferable added to the Container Information Library and the other required information obtained, preferably using said Product Information Update Means. As a non-limiting example, said additional information may include one at least of the types of information stored and/or able to be stored in said Container Information Library.
         It is preferable that at a minimum the Producer information, the Variety of Wine and the Vintage for said bottle to be inserted, are stored in said Container Information Library.
         It is preferable that said Container Information Library includes a digitised voice print for said Producer Information, the variety of wine and the vintage. This is particularly the case if subsequent retrieval of the bottle may use voice input commands.
         Other useful and non-limiting information preferably includes the bottle diameter and/or length. Without this information, the CSCM may select an inappropriately sized receptacle means.
         It is preferable that said CSCM is coupled to a Product Information Update Means (PIUM). This preferably prompts the bottle insertion means (eg human) for additional information—preferably at least sufficient to meet the basic functions of the system. It is preferable that one at least of the following non-limiting examples may be used to input said additional information:—
         Voice input means. This may particularly apply if one at least digital voice prints may be required for part at least of the information at a subsequent period.
         Keyboard commands.
         Mouse commands.
         Touch screen commands.
         Image capture means eg. bar code scanning, Image Sensor Means (eg National Semiconductor CMOS Image Sensors).
         The invention preferably allows that one at least Barcode means may be replaced and/or augmented by one at least RFID means and/or other electronically accessible semiconductor means.
      Image Capture input Means:—As a non-limiting example, it is preferable that one or more labels and/or other indicia means attached (and/or otherwise coupled) to one at least bottles of wine may be used, in part at least, as the Product ID Means.
         As a non-limiting example, it preferable that an image capture means (eg National Semiconductor CMOS Image Sensors) may be used to digitise said label information. It is preferable that said CSCM is coupled to a character recognition means to process said information. It is preferable that said information includes the product Barcode.
         It is preferable that any additional information required for the Container Information Library is obtained by one at least of the means described in the previous section for Barcode Input Means.
      Data Entry Means:—As a non-limiting example, it is preferable that part at least of the Product ID Means may be entered using one at least of keyboard means, and/or mouse means and/or touch screen means.
   It is preferable that there is a Product Constraint Means to communicate to the CSCM, user input constraint information about the bottle(s) of wine to be inserted.
      As a non-limiting example, this preferably may include a Preferred Storage Location Constraint.
      As a non-limiting example, this preferably may include information about how frequently the wine may be rotated in its CRM. This is referenced as Bottle Rotation Constraints.
      As a non-limiting example, this preferably may include information about minimum and/or maximum times the bottle is preferably stored for. This is referenced as Bottle Usage Constraints.
   It is preferable that said CSCM is coupled to a Receptacle Selection Means, wherein as non-limiting examples, one at least of the following sources of information:—
      Container Information Library,
      Container Occupancy Means
      Spatial Receptacle Library,
      Receptacle Constraints Library,
      Receptacle Information Library,
      Product Constraint Means,
      Product ID Means

To preferably facilitate determining the available CRM that may be used for the bottle(s) requiring insertion.
It is preferable that said Receptacle Selection Means may activate an Indicator Means to direct the Container Insertion Means (eg, one at least humans) to the location of one at least CRM that are available for insertion of said bottle of wine.
   The preferred indicator means is a visible indicator.
      The preferred visible indicator is one at least LED's and/or OLED's and/or LEP's.
      The preferred activation means to illuminate said visible indicator is by the application of a suitable voltage and/or current.
         It is preferable that said illumination means may be external to one at least CRM (eg the front surface of said CSM).
         It is preferable that said illumination means may be internal to one at least container means, with the light preferably visible emerging from said CRM.
   It is preferable that for each receptacle means in said container storage means, there is an adjacent indicator means such that when activated (and/or inactivated) it is clear which CRM it is associated with.
      The invention preferably allows that one at least indicator means may be associated with a plurality of CRM.
      The invention preferably allows that one at least CRM may not be associated with any indicator means.
   One at least indicator means are preferably directly and/or indirectly electronically addressable.
   One at least indicator means are preferably activated by sending an electrical and/or optical and/or wireless (eg R/F and/or IR) activation means to said electronic address.
      Said activation means preferable originates, in part at least, from said Receptacle Selection Means.
         Said Receptacle Selection Means preferably locates the address of the required Indicator Means—as a non-limiting example, by examining said Receptacle Information Library, and preferably directly and/or indirectly initiates said activation means. It is preferable that Product ID Means pertaining to the bottle(s) inserted is stored in a manner that links it with said electronic address.
   It is preferable that one at least of the following non-limiting insertion options may be provided:—
      Said Receptacle Selection Means activates one Indicator Means at the insertion destination for said bottle.
      Said Receptacle Selection Means activates one Indicator Means for each bottle requiring insertion. If plural bottles have different Product ID Means, it is preferable that the indicator means for a First Product ID Means appears different to that required for a Second Product ID Means.
         Non-limiting examples of different indicator means preferably may include one at least of the following:—
         Flashing different indicator means at different rates (including not flashing)
         Different coloured indicator means at the same location (eg there may be a red, green and blue LED constituting a particular indicator means).
      Said Receptacle Selection Means activates surplus Activation Means to those required to insert the bottle(s). Said surplus may be all available CRM.
   It is preferable that there is an Insertion Confirmation Means, to validate insertion in the correct location(s). An incorrect insertion may represent an error by the Container Insertion Means or a deliberate action by said Container Insertion Means.
      The preferred Confirmation Means is to wait for one at least Bottle Detection Means to transition from inactive to active.

Non-limiting examples of Indicator Means preferably may include:—
Means to make one at least containers (eg bottles) project in part at least from one at least CRM, relative to the projection of one at least other containers. For example the base of one at least CRM may include electromechanical means to push one at least containers from said CRM in part at least.
One at least containers preferably may be restrained in one at least Container Receptacle Means by a Bottle Restraining Means, and the release of one at least said bottle restraining means preferably may be a non-limiting example of an Indicator Means.
One at least containers preferably may be closed by a door means, and release of said door latch/lock (preferably by automated means) preferably may act as an indicator means (one at least doors preferably may open in part at least upon release of said door latch means). One at least door means preferably may include insulating means (eg double glazed glass)

Locating Bottles of Wine Stored in a CSM.

A preferred non-limiting objective of the present invention seeks to describe an automated means to facilitate the localisation of one at least bottles of wine stored in a Container Storage Means. This is referenced as the Stored Container Localisation Means or SCLM.
A preferred means of facilitating localisation of said beverage containers is to activate (and/or inactivate) an Indicator Means to direct the Container Removal Means (eg. one at least humans) to the Container Receptacle Means that stores the desired bottle(s) of wine.
   The preferred indicator means is a visible indicator.
      The preferred visible indicator is one at least LED's and/or OLED's and/or LEP's.
      The preferred activation means is to illuminate said visible indicator by the application of a suitable voltage and/or current.
         It is preferable that said illumination means may be external to one at least CRM (eg the front surface of said CSM).
         It is preferable that said illumination means may be internal to one at least container means, with the light preferably visible emerging from said CRM.
   It is preferable that for each receptacle means in said container storage means, there is an adjacent indicator means such that when activated (and/or inactivated) it is clear which CRM it is associated with.
      The invention preferably allows that one at least indicator means may be associated with a plurality of CRM.
      The invention preferably allows that one at least CRM may not be associated with any indicator means.
   One at least indicator means are preferably directly and/or indirectly electronically addressable.
   One at least indicator means are preferably activated by sending an electrical and/or optical and/or wireless (eg R/F and/or IR) activation means to said electronic address.
      Said activation means preferably originates, in part at least, from the Container Storage Control Means (CSCM).
      Said activation means is preferably initiated by an input to said CSCM.
         Said input is preferably initiated by one at least humans.
         Said input preferably includes the parameters pertaining to the bottle(s) of wine that said CSCM is being requested to facilitate locating.
         Said input preferably includes information pertaining to the number of bottles of wine matching said parameters that the CSCM is being requested to facilitate location thereof.
         Said input is preferably facilitated by one at least of the following:—
         Voice Input—preferably processed by voice recognition means coupled to said CSCM.
         Said voice input is preferably human and/or machine generated.
         Keyboard.
         Mouse.
         Touch screen.
When attempting to locate the position in said CSM of a bottle of wine matching certain parameters, it may be that there are no bottles matching the parameters. In this case it is preferable that no indicator means is activated. It is preferable that a No Bottle Found Means is coupled to said CSCM, to indicate that no match was found. Non-limiting preferred examples of a No Bottle Found Means may include one at least of:—
   the activation of multiple indicator means, preferably on a flashing basis, for some period of time.
   Output a message to a display means.
   Output an audio message, eg using a speaker means.
It is preferable that a Parameter Modification Means (PMM) is provided to allow modification of said parameters.
   It is preferable that said PMM may be user programmed to be made accessible:—
      automatically (eg. in response to an active state for the No Bottle Found Means); and/or
      in response to user input.
When attempting to locate the position in said CSM of at least one bottle of wine matching certain parameters, it may be that there are additional bottles matching the parameters compared to the actual number required. It is preferable that there is a Plural Resolution Means to handle this outcome. As non-limiting examples, it is preferable that one at least of the following are options:—
   All or a subgroup of valid indicator means are activated.
   Only one of the valid indicator means are activated if only one bottle is required.
      Said one preferably may be random.
      Said one preferably may be based on preferably predetermined parameters.
   Only the required number of valid indicator means are activated to match the number of bottles required.
It is preferable that the invention includes a means to facilitate the location of plural groups of bottles of wine, wherein each singular group may be one at least bottles, and said plural groups each have different parameters applied to them. As a non-limiting example, one may be looking for a bottle of Burgundy (group 1) and two bottles of Riesling (group 2).
   As non-limiting examples, one at least of the following indicator means may be implemented:—
      Identical indicator means are activated at the CRM containing the required groups.
      Different indicator means are activated to localise the different groups.
         Non-limiting examples of different indicator means preferably may include one at least of the following:—
         Flashing different indicator means at different rates (preferably including “on always when active”)
         Different coloured indicator means at the same location (eg there may be a red, green and blue LED constituting a particular indicator means).
It is preferable that the invention includes a means to permit plural humans to input their own localisation requests, preferably without constraints on when each may input their requests. As such it may be that in the same time period, indicator means may be active concurrently for multiple requests, some at least from plural sources.
   A non-limiting example of where this may be particularly applicable may be a retail wine outlet. Said outlet may use, in part at least, the means of the present invention to display their wines for sale. It is likely that on occasions there may be plural customers in the shop wishing to make their selections concurrently.
      It is preferable that one at least first indicator means may be and/or may be made to appear distinct from one at least second indicator means.
         It is further preferable that a first person associates said first type indicator means with their requests, and a second person associates their requests with a second type indicator means.
         Non-limiting means of different indicator means preferably may include one at least of the following:—
         Flashing different indicator means at different rates (including on always)
         Different coloured indicator means at the same location (eg there may be a red, green and blue LED constituting a particular indicator means).

A preferred non-limiting objective of the present invention seeks to describe an automated means to facilitate the rotation of a bottle of wine within one at least Container Receptacle Means. The preferred means is for said CSCM to determine that rotation is due, and to flag this to an operator at the time of a normal operation (eg insertion and/or removal). It is preferable that a flashing indicator means is used to signal the bottle that requires rotation. The invention preferably allows for one at least electronic and/or mechanical means (eg motor) to automatically rotate one at least containers (eg bottles of wine).

A preferred non-limiting objective of the present invention seeks to describe a means to facilitate temperature monitoring of one at least bottles of wine stored in one at least Container Receptacle Means. This may be referenced as the Container Thermoregulation Means or CTM. A non-limiting example of a CTM preferably may include one at least digital thermometers. The invention preferably allows for a Temperature Control Means to preferably maintain one at least CRM and/or containers within one at least temperature ranges (preferably predetermined). A non-limiting example of a Temperature Control Means preferably may include the entry of coolant and/or heating means (eg air and/or liquid) into one at least openings in one at least CRM. Said entry is preferably facilitated by a pump means. Said coolant is preferably cooled by a refrigerant means coupled to one at least Container Storage Means. Said heat means is preferably facilitated by a reverse cycle refrigerant means. The invention preferably allows for one at least CRM to have an outlet means for said coolant and/or heating means. The invention preferably allows that entry of said coolant and/or heating means into one at least CRM may be controlled, and a non-limiting example of said controlled preferably may include an electronic valve means. Said electronic valve means preferably may be facilitated by Shaped memory Alloys (eg. Nitinol Wire). The invention preferably allows that exit of said coolant and/or heating means from one at least CRM may be controlled, and a non-limiting example of said controlled preferably may include an electronic valve means. Said electronic valve means preferably may be facilitated by Shaped memory Alloys (eg. Nitinol Wire). One at least Container Storage Means preferably includes pipe means to distribute coolant means and/or heating means, from one at least Refrigeration Means (that preferably may include a reverse cycle means) and/or heating source means, to one at least Container Receptacle Means, and/or the reverse direction. Said Temperature Control Means preferably may include Humidity Control Means. Opening and/or closing of one at least electronic valve means is preferably in response to a signal means. Said signal means is preferably electronic. Said signal means is preferably facilitated by one at least electronic means coupled to one at least Container Storage Means. Said electronic means preferably includes a microprocessor means. Said open and/or close is preferably facilitated by an electronic switch means. Said switch is preferably a relay and/or semiconductor switch.

A preferred non-limiting objective of the present invention seeks to describe a Container Receptacle Cleanup Means. Over time the arrangement of bottles within a CSM may become sub-optimal. It is preferable that there is a means to rearrange the bottles. The preferred means is to have the Container Storage Control Means activate an indicator means at a first location to signal that the bottle should be removed (eg using a flash rate of one second) and activate an indicator means at a second location (eg with a flash rate of four per second) to signal the bottles destination. This process preferably may be repeated until the housekeeping duty is completed.

A preferred non-limiting objective of the present invention seeks to describe an Error Reporting Means. Said CSMCM preferably report operational and/or other errors. The preferred error output means is audio and/or display means.

The invention preferably includes a regulated power supply that preferably may run off mains voltage. The output voltages are preferably compatible with digital logic—non-limiting examples of which preferably include two at least of ground (+/−1 volt); +3.3 volts (+/−1 volt); +5 volts (+/−1 volt); +12 volts (+/−3 volts); −12 volts (+/−3 volts). It is preferable that part at least of said voltages may be maintained by a battery backed means.

The invention preferably allows for the method step of producing and/or distributing and/or installing software for use with part at least of the invention. The preferred means of said delivery preferably include one at least of:—
Internet
CD ROM
DVD.

The invention preferably allows for the method step and means of securely encrypting and/or decrypting and/or processing part at least of the means coupled to said CSCM and/or one at least means described in this specification.

The invention preferably allows for the method step and means of password protecting access to one at least functions provided by said CSCM and/or one at least means described in this specification.

As a non-limiting example, in large installations it may be advantageous to have Section Indicator Means, to direct one or more extraction means, to one at least part of the CSM. As a non-limiting example, it is preferable that an illuminated means (preferably prominent) is located on the top (and/or in any other easily seen position) of a block of modules. It is preferable if said illuminated means flashes when active.

The invention preferably includes the method step of manufacturing said Container Storage Means and/or one at least means described in this specification.

The invention preferably allows for the use of one at least Container Storage Means and/or one at least means described in this specification in one at least outlets for the sale of alcoholic beverages (eg a bar, pub, hotel, cocktail lounge).

The invention preferably includes the method step of manufacturing and/or distributing, and/or selling, part at least of said CSM and/or one at least means described in this specification.

The invention preferably includes the method step of advertising and/or promoting part at least of said CSM and/or one at least means described in this specification.
Said advertising preferably may include television, cinema and printed matter as non-limiting examples.

The invention preferably includes the method step of ordering, and/or selling (that may include sale, and/or hire, and/or rental and/or leasing, as non-limiting examples) and/or exporting, and/or importing, and/or transporting:—
from a first jurisdiction to one at least second jurisdiction, and/or from a first location to one at least second locations, said CSM and/or one at least means described in this specification.

The invention as described thus far has dealt with the storage of bottles of wine. Quite clearly it preferably may also be applied to wine in any container means. The invention preferably allows for the storage of wine in any container means, non-limiting examples of which preferably include one at least of:—
Glass Bottles; Plastic Bottles; Metal Bottles; Ceramic Bottles; Cans (eg aluminum and/or steel); Casks, Plastic Sachets and/or bags; Barrels.

The invention preferably allows that one and/or plural types of container means may be stored using the means of the invention. Said plural preferably may be concurrent.

Furthermore, the invention preferably may be applied to any type of alcoholic beverage in said container means. Non-limiting examples of said alcoholic beverages preferably may include one at least of:—
Beer; Cider; Spirits; Liqueurs; Cocktail Mixer Drinks.

The invention preferably allows that one and/or plural types of alcoholic beverages, preferably may be stored in one or plural types of container means using, in part at least, the means of the invention. Said plural types of alcoholic beverage and/or said plural types of container means preferably may be concurrent.

The invention preferably allows that the phrase ‘alcoholic beverage’ in this specification may be replaced in part at least with the word ‘beverage’. Said beverage preferably may be alcoholic and/or non-alcoholic.

The invention preferably allows that the use of the term ‘Content Means’ may be understood as representing one at least of:—
Wine,
Alcoholic beverage,
Beverage.

The invention preferably allows that the use of the term Container Means in this specification preferably refers to the Container Means plus its Content Means. This preferably does not preclude the use of empty Container Means with the means of the invention.

Those experienced in the art will appreciate that the means described for storing liquids may be applied to the automated storage and/or retrieval of other means.

### THE PREFERRED EMBODIMENT OF THE INVENTION

Figure One of the drawings shows a non-limiting embodiment of the electronics for a Module Receptacle Electronic Means (10. The Printed Circuit Means (1a) is preferably mounted at the back of the MRM. The electronics described in this example preferably use one at least RFID reader means coupled to one at least MRM's, and one at least RFID Transponder means coupled to one at least bottles. The PCB (1a) shown includes an RFID reader means for each Container Receptacle Means (CRM) in the MRM to which it may be coupled. Each RFID Reader Means preferably includes an Antenna Means (3) (eg etched traces on the PCB) and reader electronics (2).

The preferred Indicator Means in the present example is one at least LED's (4) for each CRM coupled to said electronic means (1). As a non-limiting example, the LED's may be grouped around the periphery of each antenna means (3). It is preferable that when a particular CRM is to be highlighted (eg Indicator Means activated) that the relevant LED's are arranged such that when illuminated, their light shines from the back of the associated CRM emerging from the front. The invention preferably allows that one at least LED's (and/or group of LED's) may be made to emit light in a plurality of colours and/or flash rates.

One at least electronic means (1) preferably includes a microprocessor and memory means (8). said memory preferably includes computer readable and/or writeable data and/or computer programs that facilitate the operation of part at least of the means of the invention. One at least electronic means (1) preferably include a means to interface to power/ground/electrical signal, for example a D-connector (9). There is preferably a means for one at least electronic means (1) to make wired and/or wired connections with a plurality of other mean (eg plural electronic means). One at least electronic means (1) preferably may interface to one at least other Module Receptacle Electronic Means and/or one at least Container Storage Control Means via optical means (10) and/or wireless means (eg bluetooth, zigbee) (11).

One at least electronic means (1) preferably may include one at least temperature detection means (13) (eg digital thermometer). Said temperature detection means (13) preferably may be electrically connected to a conducting means (14) that may permit detection means (13) to sit beneath one at least bottles located in one at least CRM.

One at least embodiment of the invention preferably allows for temperature control means (eg cooled air) to flow to and/or from one at least CRM's. Said Temperature Control Means may be referenced generically as “Coolant” in this specification. As a non-limiting example, one at least PCB's (1) preferably may include one at least openings (6) to facilitate flow of said “Coolant” (eg permit passage of one at least pipes).

One at least electronic means (1) preferably may include a Coolant Control Valve Interface (7) to preferably permit a control means (eg microprocessor (8)) to control opening and/or closing of one at least means (eg valve) to control entry and/or exit of “Coolant”.

One at least electronic means (1) preferably may include a Module Indicator Means (5) to indicate that said the coupled MRM includes one at least presently active CRM. This preferably may be used as a non-limiting example of a Section Indicator Means. One at least Section Indicator Means preferably may have coded output (eg colour(s), flash rate) to target it for a particular user from a plurality of potential concurrent users.

One at least electronic means preferably includes a means (eg hole (12)) to facilitate coupling of said electronic means (1) to one at least Module Receptacle Means. As a non-limiting example, one at least MRM preferably include one at least posts (eg metal, plastic) that may be constructed to form a snap lock fitting with one at least holes (12), when said electronic means (1) is appropriately applied to said MRM.

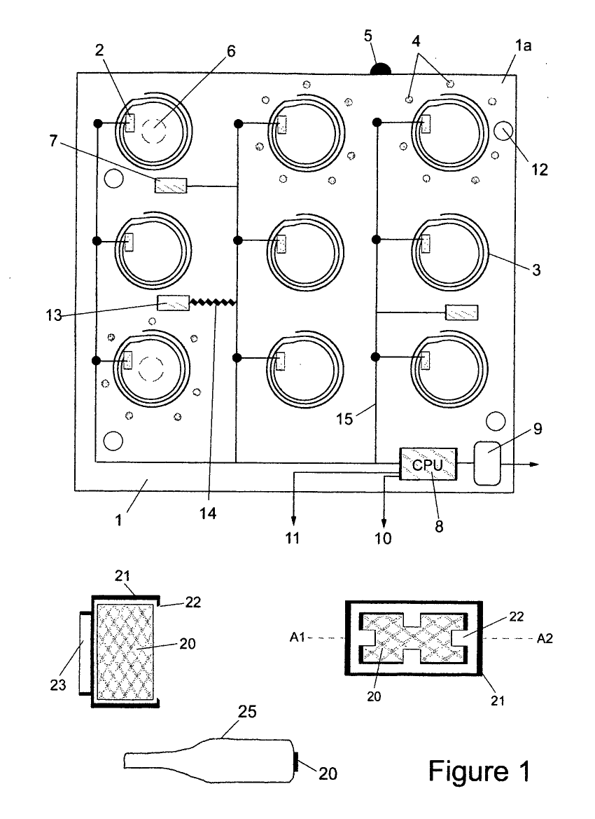

FIG. 1 of the drawings also depicts a preferred means of electronically tagging one at least bottles (25) (eg of wine) with an electronically readable (and preferably writeable) ID means (20). The preferred ID device is electrically operable eg. RFID transponder, Dallas Semiconductor Onewire device. It is preferable that one at least electronic ID devices (20) may be reversibly attached to one at least bottles and may preferably be used on at least one subsequent occasion. A non-limiting example of said reversible attachment preferably may include a ID device carrier means (21) (eg. moulded plastic) that includes a container (eg bottle) attachment means (23) (eg glue) and an ID device retaining means (22). One at least ID devices preferably may press fit into one at least container attachment means (21) depicted as two different cross sections in the drawings. One at least ID device retaining means (22) preferably includes a bevel means to facilitate said press fit. As a non-limiting example, one at least retaining means (22) preferably may be snapped off (in part at least) to release said ID device (20). As a non-limiting example one at least attachment means preferably may be an adhesive means protected by a removable cover (eg paper) that when removed facilities adhesion of said ID device carrier means (21) to one at least Container Means (25). A magnetic coupling (not shown) is another preferred example of a method of reversibly attaching an ID device to an ID device carrier means.

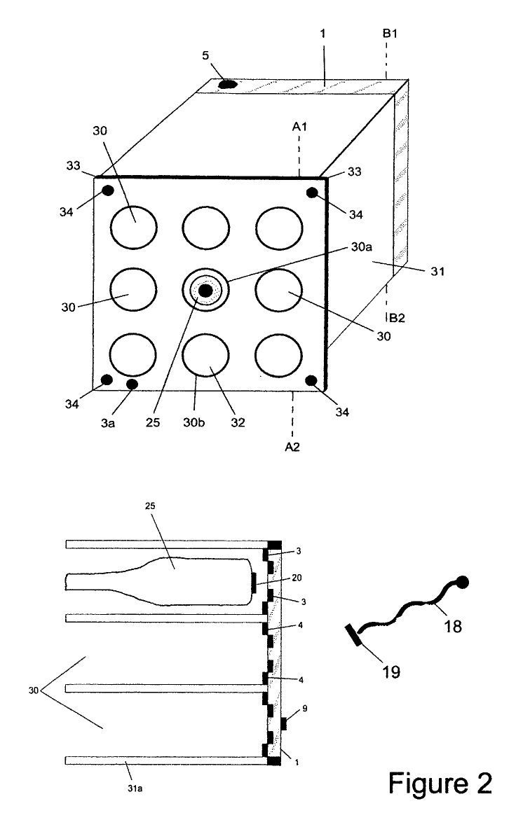

FIG. 2 of the drawings depicts a preferred example of a Module Receptacle Means (31). One at least MRM (31) preferably include one at least Container Receptacle Means (30). One at least CRM (30) are preferably formed by one at least voids in one at least MRM (31). Non-limiting examples of MRM's preferably may include:—i) one or more pipes (eg terracotta) stacked horizontally and/or vertically (and preferably fixed together); ii) Timber (eg block of wood with holes carved/bored/drilled to create CRM's); iii) Stone (eg block of stone with holes carved/drilled/bored to create CRM's); iv) Plastic (eg injection moulded). It is preferable that one at least voids surrounding one at least CRM may be filled with insulating means (eg polyurethane foam). The drawing of FIG. 2 shows the electronic means (1) attached to the rear of said MRM (31). The top end of a bottle (25) is shown in the central CRM (30a). Light (32) is shown emanating from the activated middle bottom CRM (30b). The invention preferably allows that one at least CRM may be coupled to an Indicator Means located on one at least external surfaces of one at least MRM, for example LED (4).

One at least MRM preferably includes a means to facilitate mounting of said MRM to a CSM Mounting Means. As a non-limiting example, one at least MRM (31) preferably may include a Flange Means (33), that preferably includes one at least mounting holes (34), to preferably facilitate fixing (preferably reversibly) of one at least MRM to said Mounting Means.

The bottom drawing of FIG. 2 depicts MRM (31) in section through lines A1-A2 and B1-B2 of the top drawing. The outer base wall of said MRM (31a) is shown, together with a section through CRM's (30). A bottle (25) with its attached transponder (20) is depicted in the top CRM. The antenna (3) coupled to electronic means (1) are shown oriented in a manner to facilitate reading said transponder (20). The LED's (4) are preferably arranged to shine light down their respective CRM's when activated. A connector means (9) (eg socket), for example, preferably may interface said electronic means (1) with one at least other electronic means and/or Container Receptacle Control Means. A non-limiting example of a wired interface means is shown as plug (19) that preferably mates with socket (9). The electrical wiring (18) is preferably long enough that it permits the associated MRM to be removed from one at least CSM Mounting Means.

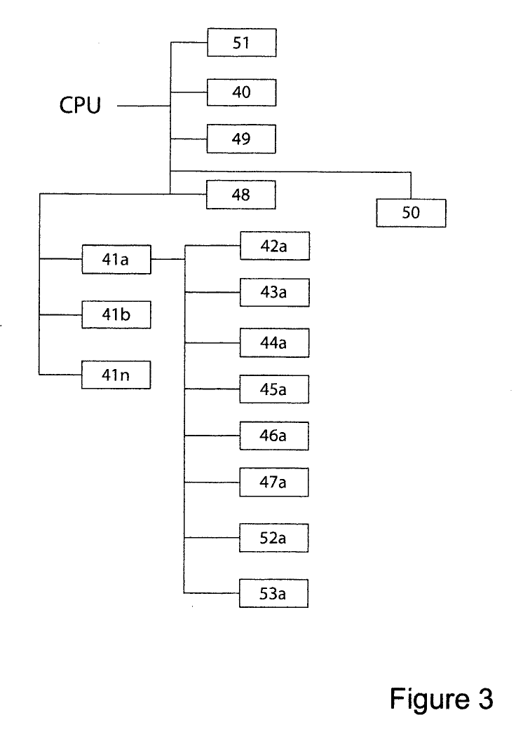

FIG. 3 of the drawings depicts a preferred example means for arranging data coupled to CPU means (8) coupled to one at least electronic means (1).

Memory Storage Means coupled to one at least Microprocessor Means (8) preferably may store, one at least of the following non-limiting examples:
One at least Module ID's (40).
One at least Module Indicator Flags (50) to indicate if one at least MRM Indicator Means (5 of FIG. 1) is active or inactive.
One at least Facade Latch Means (51) to indicate if one at least means coupling part at least of one at least Facade means to the MRM(s) associated with said Microprocessor Means (8) (for example) are open or closed; and/or if said facade is attached or unattached.
One at least CRM ID's (41a), (41b), . . . (41n). There is preferably a CRM ID (41) for each CRM (30) associated with said Microprocessor Means (8). Each CRM ID (42) is preferably unique to other CRM ID's.
The Container ID (42a) of one at least Containers (25) that may presently be located in one at least CRM's (30). Said container ID (42) is preferably provided by one at least transponder means (20) (as a non-limiting example). The absence of a Container ID Means (42) for one at least CRM ID's (41) preferably may indicate a vacant CRM.
One at least CRM ID Storage Means (41a) is preferably associated with an Active Flag Means (45a) to indicate whether the Indicator Means (3) associated with the CRM (30) represented by said CRM ID (41a) is currently active or inactive.
One at least CRM ID locations (41a) preferably may be associated with Temperature Measurement Information (43a) pertaining to one at least associated CRM.
One at least CRM ID Means (41a) preferably may be associated with Coolant Valve Means information (44a) (eg OPEN/CLOSED).
One at least CRM ID (41a) preferably may be associated with a Container Weight Means (46a) to preferably record the weight of one at least Container Means (preferably including contents) presently stored within one at least CRM associated with said CRM ID (41a). The invention preferably allows for plural Container Weight means to be associated with one at least CRM (eg store the weight of said Container Means before removal from its associated CRM and after reinsertion).
One at least CRM ID (41a) preferably may be associated with Door Lock Status (47a) eg to record whether or not one at least locks, associated with one at least CRM associated with said CRM ID (41a), is locked and/or unlocked. A non-limiting example of said lock may be to secure a door means that may be used to restrict access to said CRM.
One at least CRM ID (41a) preferably may be associated with Door Open Status (52a) to record whether or not one at least means (eg door) to restrict access to the associated CRM is open or closed.
One at least CRM ID (41a) preferably may be associated with CRM User ID (53a) eg to record the identity of one at least user with access rights to one at least CRM's (for example). For example, it may record the electronic User ID of one at least users with permission to access one at least CRM's associated with said CRM ID (41a); and/or the electronic User ID of one at least users banned from accessing one at least CRM; and/or the electronic User ID of the last person to remove a Container Means from one at least CRM; and/or the electronic User ID of the last person to insert a Container Means into one at least CRM.
One at least Local Resources (49) eg software routines and/or data.

One at least System Resources (48) preferably may facilitate operations of one at least Microprocessor Means (8).

One at least other electronic means (eg CSCM) preferably may directly and/or indirectly address said CPU (8) by wired (eg optical (10) or conductive means (9)) and/or wireless means (11). Said CPU means (8) preferably may be able to send to and/or receive from said other electronic means information pertaining to one at least of the following examples:—
i) which associated CRM's are empty and which are occupied;
ii) the Container ID (42) of one at least bottles (for example) stored in said occupied CRM's;
iii) Module ID information (40);
iv) the status of one at least Active Flag Means (45).
v) temperature (43) of one at least CRM and/or container means.
vi) status of one at least Valve Means (44).
vii) User ID (53).
viii) Container Weight (46).
ix) CRM Door Lock status (47).
x) CRM Door Open Status (52).
xi) Module Indicator Flag Status (50).

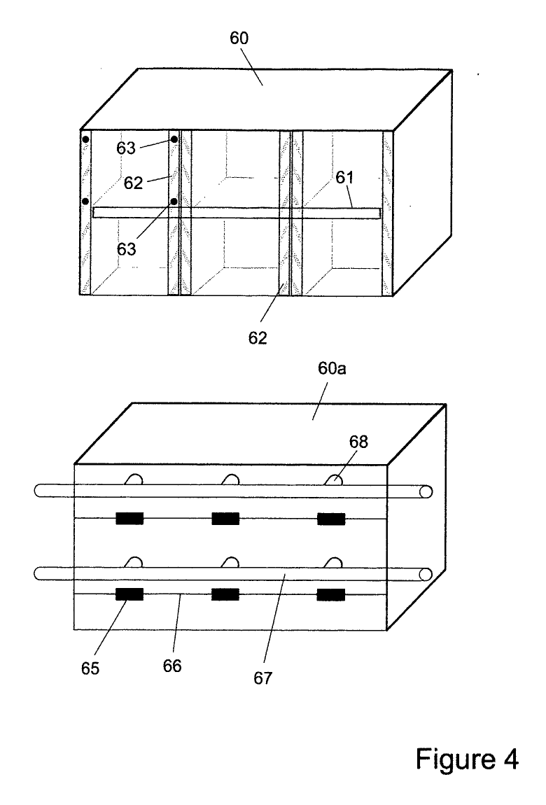

FIG. 4 of the drawings shows a non-limiting example of a CSM Mounting Means (60), (eg constructed of metal and/or plastic) that preferably may accommodate a plurality of MRM's (31). One at least Container Storage Means (CSM) preferably may include plural CSM Mounting Means (60) and said plural means preferably may not be contiguously arranged, in part at least. The invention preferably allows for one at least MRM Support Means (61) (eg shelf), and/or MRM Attachment Support Means (62) (eg a flange), and/or Mounting Means (63) (eg holes, that preferably mate with Mounting holes (34) on one at least associated MRM's).

The bottom drawing of the figure shows a non-limiting example of the back view of one at least CSM Mounting Means (60a). This preferably may include one at least Coolant Transport Means (67) (eg pipe) that preferably may transport “Coolant” to and/or from one at least CRM's (30), preferably via one at least Pipe Connection Means (68). The invention preferably allows for one at least Wired Distribution Means (66) (eg electrically and/or optically conductive) coupling i) a first means stored in said CSM Mounting Means (60) to one at least second means stored in said CSM Mounting Means (60), and/or ii) one at least means stored in said CSM Mounting Means (60) with one at least means external to said CSM Mounting Means (60). Said Wired Distribution Means (66) preferably includes one at least Conducting Coupling Points (65) to one at least Wired Interface Means (19, FIG. 2).

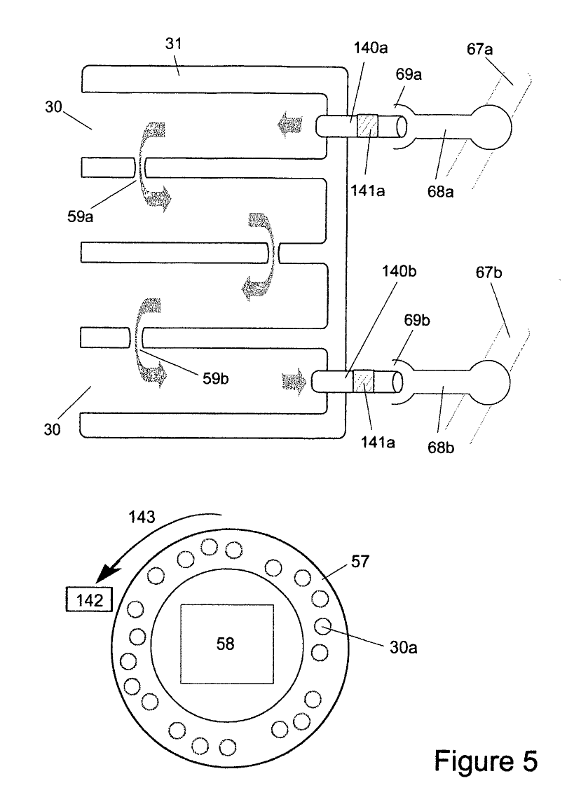

The next part of the invention is described with reference to FIG. 5 of the drawings. The invention preferably allows for one at least CRM (30) and/or MRM (31) to facilitate the flow of “Coolant” As a non-limiting example, Coolant Transport Means (67a) preferably may include one at least Pipe Connection Means (68a) that preferably includes a Pipe Coupling Means (69a) to link with one at least CRM Coolant Pipe Means (140a). The link between said Pipe Coupling Means (69a) and said CRM Coolant Opening Means (140a) preferably provides an air tight and/or fluid tight seal. One at least Coolant Flow Valves (141a) preferably may be used to control entry (and/or exit) of “Coolant” into one at least CRM's. A non-limiting example of the flow of “Coolant” is depicted by the arrows as it moves via Internal CRM Openings (eg 59a, 59b). The invention preferably allows for one at least means for “Coolant” to exit one at least CRM's (30) and/or MRM's (31), with a non-limiting example depicted in the drawing showing “Coolant” exiting via CRM Coolant Pipe Means (140b), said exit preferably may be controlled by one at least Coolant Flow Valves (141b), via Pipe Coupling Means (69b) and Pipe Connection Means (68b) to Coolant Transport Means (67b). The automated positioning of one at least containers/bottles preferably may also be an example of an electrically operable indicator means.

The invention preferably allows that one at least CRM and/or MRM and/or CSM may be made to move (preferably by automated means) from a first location to a second location. As a non-limiting example, one at least CRM's (30) preferably may be arranged on a Carousel Means (57), and for example, one at least operators (58) may be located inside said carousel. It is preferable that one at least CRM's may move from a first position (eg a position difficult to reach for said operator) into a second position (eg in front (142) of said operator (58)). Said movement preferably may be in response to activation of one at least Indicator Means (not shown). For example, CRM (30a) may have its associated Indicator Means activated by a CSM Control Means that preferably may also signal a servomechanism (for example) to rotate said Carousel Means (57) such that CRM (30a) moves, eg around curve (143), to a position (142) in front of the operator (58).

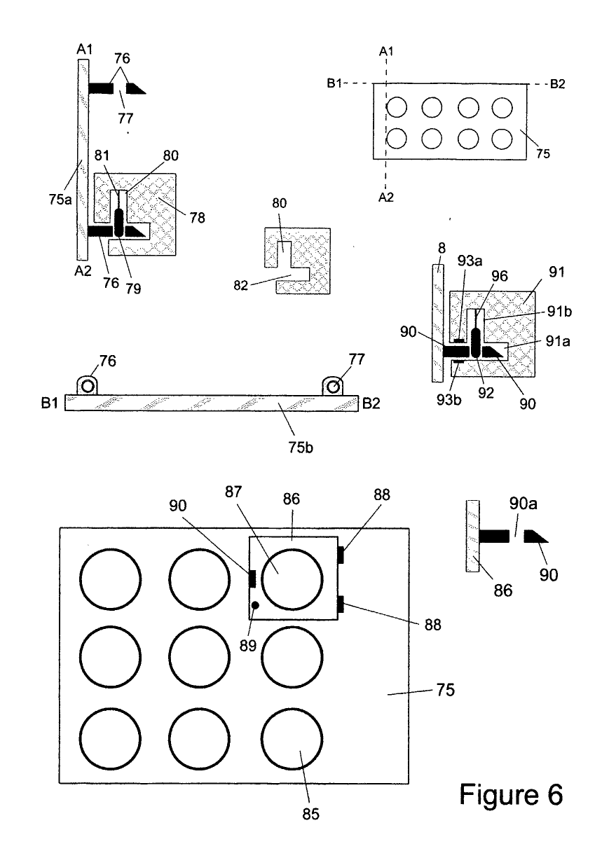

The next part of the invention is described with reference to FIG. 6 of the drawings. The invention preferably allows for one at least Facade Means (75) to attach (preferably reversibly) to one at least parts of one at least Container Storage Means. A view of Facade Means (75a) is formed by a plane coming out of the page through line A1-A2. A second view of said Facade Means (75b) is formed by a plane coming out the page through line B1-B2. One at least Facade Means (75a) preferably includes one at least Facade Attachment Means (76), that in the present example are preferably metal and/or plastic plates protruding from the back surface of said Facade Means (75). Said Facade Attachment Means (76) preferably includes a Facade Retention Receptacle Means (77) (eg a hole). One at least CSM preferably include one at least Facade Retention Means (78) to facilitate coupling of said Facade Means (75) to said CSM. The preferred method is to include said Facade Retention Means as part of one at least Container Mounting Means (60) and/or MRM's. An example of said Facade Retention Means is depicted in the drawing, wherein a housing means (eg cast metal, moulded plastic) preferably includes a Facade Attachment Receptacle Means (82) (eg a void) to receive said Facade Attachment Means (76) and a Facade Locking Means Receptacle (80), that preferably houses a Facade Locking Means (79) (eg metal and/or plastic pin) that preferably may insert into a Facade Retention Receptacle Means (77) to restrain Facade Attachment Means (76). There is preferably a Facade Locking Retraction Means (81) to retract said Facade Locking Means (79) from said Facade Retention Receptacle Means (77) (eg to permit said Facade Means (75) to be removed. An example of said retraction means preferably may include Shaped memory Alloy (SMA) (eg Nitinol Wire) that preferably may contract when heated (eg by electric current). There is preferably a means (not shown) to facilitate insertion of said Facade Locking Means (79) into said Facade Retention Receptacle Means (77) (eg a coiled spring, length spring steel, length tensile plastic). The insertion and/or retraction of one at least Facade Locking Means (79) into and/or from one at least Facade Retention Receptacle Means (77) is preferably facilitated by one at least Microprocessor means (8) and/or CSM Control Means, and preferably under the direction of one at least persons (eg keyboard commands, voice commands, display menu selection, pointing device). For example, said Microprocessor (8) may control application of current to one at least SMA means.

It will be appreciated that the means described for attaching one at least Facade Means to one at least CSM, optionally may be adapted by those experienced in the art to attach one at least Facade Means to one at least other means—eg, the wall of a building, and/or said Facade Means may be a decorative cover/enclosure for a portable electronic means (eg cellular telephone, PDA, Key Tag).

The invention preferably allows for one at least openings (85) in one at least CRM 30 and/or Facade Means (75) to be reversibly covered, in part at least. An example of said Covering Means preferably includes one at least Door Means (86). One at least doors preferably includes one at least of a Hinge Means (88); Handle Means (89); Door Lock Attachment Means (90), that preferably includes a Door Attachment Receptacle Retention Means (90a) (eg hole). One at least CSM preferably includes one at least Door Lock Means (91) that are preferably attached to one at least Facade Means (75) and/or CSM mounting Means (60) and or MRM's (31). An example of said Door Lock Means (91) preferably may include a Door Lock Attachment Receptacle Means (91a) (eg a void) to receive said Door Lock Attachment Means (90); and a Door Locking Means Receptacle (91b), that preferably houses a Door Locking Means (92) (eg metal and/or plastic pin) that preferably may insert into Door Attachment Receptacle Retention Means (90a) to restrain Door Lock Attachment Means (90). There is preferably a Door Locking Retraction Means (96) to retract said Door Locking Means (92) from said Door Attachment Receptacle Retention Means (90a) (eg to permit said Door Means (86) to be opened and/or closed. An example of said retraction means preferably may include Shaped memory Alloy (SMA) (eg Nitinol Wire) that preferably may contract when heated (eg by electric current). There is preferably a means to facilitate manual closing of one at least Door Means (86)—eg bevelling part of Door Lock Attachment Means (90) and/or Door Locking Means (92). One at least Door Means (86) is preferably coupled to a Door Status Detection Means to determine if one at least doors is open and/or closed. An example of said Door Status Detection Means preferably may include a First Electrode Means 93a and a Second Electrode Means (93b) such that a closed door (for example) may allow current to flow between said First And Second Electrodes. There is preferably a means (not shown) (eg a coiled spring, length spring steel, length tensile plastic) to facilitate insertion of said Door Locking Means (92) into said Door Lock Receptacle Retention Means (90a). The insertion and/or retraction of one at least Door Locking Means (92) into and/or from one at least Door Lock Receptacle Retention Means (90a) is preferably facilitated by one at least Microprocessor means (8) and/or CSM Control Means, and preferably under the direction of one at least persons (eg keyboard commands, voice commands, display menu selection, pointing device). For example, said Microprocessor (8) may control application of current to one at least SMA means.

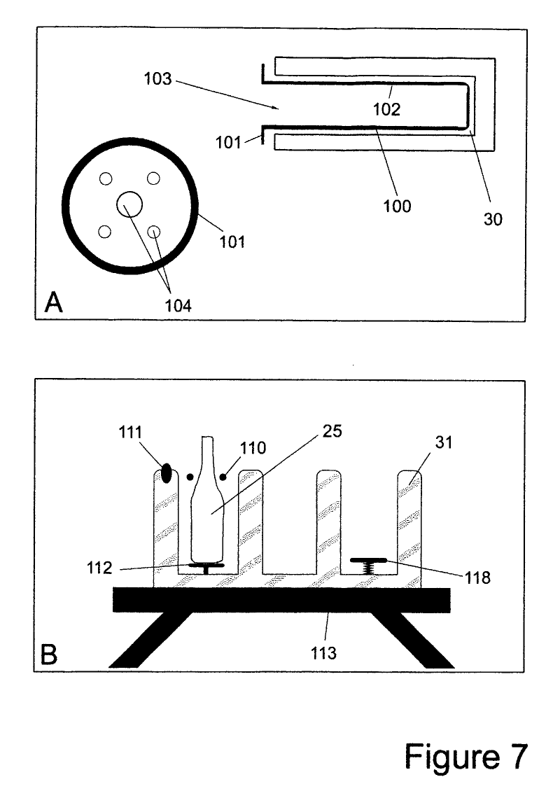

The next part of the invention is described with reference to Block Drawing A of FIG. 7 of the drawings. One at least CRM's (30) preferably may have a Decorative Means (100) that preferably may be reversibly attached to one at least CRM's (30). An example of said Decorative Means (100) preferably may include a cylindrical means lined with fabric (eg velvet). For example, said Decorative Means (100) preferably may be inserted through the front opening in one at least CRM's (and preferably where applicable, the opening in one at least Facade Means (75). One at least opening (103) in said Decorative Means (100) preferably may include a Decorative Trim (101), for example, gold plated metal band. Said Decorative Trim (101) preferably may stop against the external surface of one at least CRM's and/or MRM's and/or Facade Means. One at least Decorative Means (100) preferably includes one at least service openings (eg for CRM Coolant Pipe Means (140a) and/or allow entry of light from one at least LED's (4)).

The next part of the invention is described with reference to Block Drawing B of FIG. 7 of the drawings. The invention preferably allows that the orientation of one at least CRM and/or MRM are not limited. For the storage on bottles of wine, for example, it is expected that associated CRM's would be oriented to allow the long access of said bottles to lay approximately horizontal with reference to the floor. The MRM embodiment (31) of FIG. 7 depicts an arrangement that stores bottles (25) in an approximately upright position, for example, one at least component beverages of one at least alcoholic cocktails may be better suited to storage in this position. The invention preferably allows that one at least CRM may include a Scale Means (112) to determine the weight of one at least bottles and/or contents in said CRM. For example the weight of said bottle may be supplied to a CSM Control Means prior to removal of said bottle from said CRM and after reinsertion of said bottle. For example, this information may be used to calculate the amount of beverage and or alcohol removed from said bottle (eg by a particular consumer). The invention preferably allows that one at least CRM may have a Container Ejection Means (118) that preferably may eject in part at least, one at least containers (preferably using automated means) from said CRM. It is preferably that said Ejector Means (118) may act as an Indicator Means (eg the protrusion of a bottle from a CRM may indicate that it is the target bottle).

One at least CRM is preferably coupled to a User ID Detector (111) that for example, preferably may read the User ID of one at least persons removing and/or inserting a container from and/or to said CRM. An example of a User ID Detector may be an RFID transponder reader. It is preferable that one at least CRM's may include a Restraining Means (110) to restrict removal and/or insertion of one at least containers into one at least CRM's. It is preferable that operation of one at least Restriction Means (110) may be influenced (as an example) by the User ID of the person attempting said removal and/or insertion. Said Restraining Means (110) preferably includes automated means.

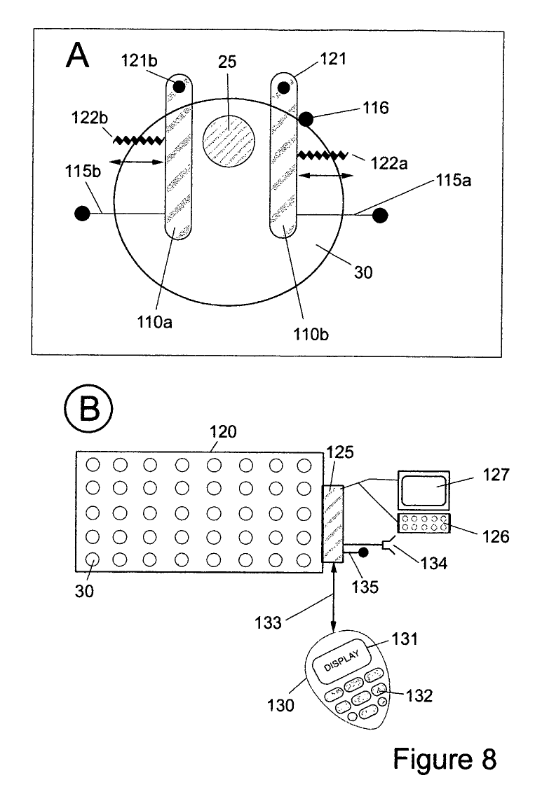

A non-limiting example of a Restraining Means (110) is shown in the top drawing of FIG. 8 of the drawings. This is a cross-section through a CRM in a plane parallel to the front/top opening of said CRM and near said front/top. For example, a pair of Restraining Arms (110a and 110b) preferably may be made to move in an arc, towards or away from the neck of a bottle (25). Said Restraining Arms (110a, 110b) preferably may rotate at Pivot Means (121a) and (121b). Said rotation is preferably facilitated by automated Means. When said arms have swung towards said neck, said bottle is preferably protected from extraction (and/or insertion, if CRM is empty (for example) and said arms are suitably positioned). As an example, said arms may be constructed from metal and/or plastic. One at least Restraining Arms (110a, 110b) are preferably coupled to an Opening Force Means (115a, 115b) to move one at least said arms (110a, 110b) away from said bottle (25), preferably permitting its release from the associated CRM (30). As a non-limiting example, said Opening Force Means (115a, 115b) preferably may include Shaped memory Alloys (SMA), for example Nitinol Wire, wherein said SMA may be made to contract by heating (eg by an electric current passing along said SMA). There is preferably a Locking Means (116) to prevent manual opening of said Restraining Arms (110a, 110b). Said Locking Means (116) preferably may be removed by an SMA Means as a non-limiting example. There is preferably a Closing Force Means (122a, 122b) (eg spring) to move one at least Restraining Arms (110a, 110b) towards said bottle (25). For example, a user of the system may wear an RFID transponder (eg on a wrist strap) that is their User ID. To access a bottle from a CRM, they may pass their RFID Wrist band in close proximity to User ID detector (111) and if validated, one at least Control Means preferably directs that one at least Microprocessors (8) pass current through SMA Means (115a and 115b) and also through SMA Means controlling the release of Locking Pin (116), permitting said Restraining Means to move apart, allowing said bottle to be removed. Said Microprocessor (8) is preferably then directed to cease current to Opening Force Means (115a and 115b) permitting Closing Force Means to push Restraining Means (110a & 110b) together. Current to the SMA maintaining Locking Means (116) in the unlocked position is preferably removed allowing said Locking Means (116) to move into a position to secure said Restraining Means (1110a, 110b) from opening. There is preferably a Force Means (not shown) to facilitate said Locking Means (116) moving into the locked position. A similar process preferably may be followed when a person wants to insert a bottle into said CRM.

A non-limiting example of a CSM Control Means (CSMCM) is described with reference to Block Drawing B of FIG. 8. This shows a Container Storage Means (CSM) (120) with a plurality of Container Receptacle Means (30) with its associated CSMCM (125). One at least CSMCM preferably includes, as non-limiting examples, processor means, memory storage means, software means, power supply means, wireless interface means (eg zigbee, bluetooth), wired interface means (eg electrical conducting, optically conducting) and user I/O Means (eg Display Means (127), Keyboard Means (126), Speaker Means (134), Microphone Means (135). Part at least, of one at least CSMCM and/or User Interface Means preferably may be included in one at least Portable Electronic Means (130), that preferably includes a Display Means (eg LCD, OLED, OLEP) (131), Keyboard Means (132), Wireless Interface Means (133). Co-pending PCT AU 03/01029 by the present inventors describes a Key Control Means that should be readily adapted by those experienced in the art to meet part at least of the requirements of said Portable Electronic Means (130) and/or CMCCM (125). The method of constructing a CSMCM are not described in detail, as the detailed specification provided in this document should enable one experienced in the art to design a suitable CSMCM.

The invention preferably allows that one at least containers may include a Secondary Restraining Means that permits said container to be removed from one at least CRM's, however, the distance that it may be taken is preferably limited (an example Secondary Restraining Means preferably may be a chain).

The present invention preferably allows for a means to facilitate mixing a plurality of alcoholic and/or non-alcoholic beverages into one at least mixed beverages (eg cocktails), wherein part at least of the process preferably uses automated and/or electronic means. Said automated means preferably facilitate the addition of other items to mix—eg slices of lemon/lime, cherries, strawberries, ice, decorative items (eg parasol), drink stirrer.

As a non-limiting example, one at least Portable Electronic Means (130) (and/or other electronic means), preferably may be programmed with the ingredients of one at least cocktails. For example, said ingredients preferably may include information concerning the volume and/or weight of one at least said ingredients, in one at least cocktails; and/or the amount of alcohol in said one at least ingredients; and/or the name(s) of one at least cocktails; and/or the colour of one at least cocktails (said colour is preferably both at various stages of mixing said cocktail and preferably the colour of the finished mix); and/or mixing instructions (eg shake, shake with crushed ice, stir); and/or preferred container (eg type of drinking glass) to use for one at least cocktails.

The means to process and/or formulate and/or otherwise facilitate the preparation of one at least cocktail mixes using electronic means is referenced as a Cocktail Formulating Means (CFP).

There is preferably a means to edit existing information stored within one at least Cocktail Formulating Means. There is preferably a means to add new information to said Cocktail Formulating Means (eg new mixes).

The invention preferably allows for one at least User Controlled Data Processing Means (eg PC) and/or Internet Means and/or portable electricaly operable device to facilitate editing and/or preparation of, and/or enhancements and/or alternatives to information stored within one at least Cocktail Formulating Means. Non-limiting example means of transferring information between one at least CFP and one at least other electronic means (eg CSMCM, Internet Means) preferably may include I/R (eg IrdA), and/or wireless (eg Zigbee, Bluetooth).

One at least CFP preferably may interface with one at least Container Storage Means Control Means.

One at least Container Receptacle Means within one at least Container Storage Means, preferably includes one at least containers (eg bottles) of ingredients for use with one at least cocktails. One at least CRM storing said cocktail ingredients preferably is oriented such that the associated container is oriented more than 45 degrees above the horizontal. One at least CRM storing said cocktail ingredient preferably may move its position (eg a carousel means) and said movement is preferably facilitated by automated means.

One at least CFP preferably may interface with one at least Intelligent Beverage Container (see below) and/or be integrated, in part at least, into one at least Intelligent Beverage Containers.

As a non-limiting example, one at least persons preferably may input into a Cocktail Formulating Means a request for one at least cocktails (and/or ask for a selection of one at least cocktails containing one at least ingredients). For example, said input may be voice, and/or keyboard, and/or menu selection from a display means. As a non-limiting example, one at least CFP preferably may respond by one at least of the following:—
1) Advise the preferred Beverage Container and/or direct Automated Means to provide the preferred Beverage Container.
2) Activating the Indicator Means on the CRM with a first ingredient in the desired cocktail mix. This preferably may be associated with the container in said CRM being partially ejected, and/or said CRM being moved from a first position to a second position. The invention preferably allows that a plurality of cocktails and/or users may be handled concurrently by one at least CSM's. It is preferable that a first colour and/or flash rate may be associated with a first user and/or cocktail mixing process and a second colour and/or flash rate may be associated with a second user and/or cocktail mixing process. For example a bar-person may be concurrently mixing a first cocktail with ingredients identified by a red light on the appropriate CRM's and the second cocktail with ingredients identified by a purple light on appropriate CRM's. In another example a first person may be mixing a cocktail concurrently with one at least second persons mixing the same and/or different cocktails. It is preferable that one at least CRM may be associated with an Indicator Means that is a first colour at a first time and one at least second colours on one at least second times. Furthermore, the invention preferably allows that one at least Indicator Means may be coupled to a means that is not a CRM and/or is not part of a CSM (for example, soda water may be served from a separate, known art means). Said indicator means preferably may be attached to the beverage container. One at least CFM preferably may assist the current user of said CFM to determine the colour and/or flash rate that they should seek on one at least CRM Indicator Means, preferably by displaying said colour and/or flash rate on part of said CFM (for example, one at least LED's on the CFM enclosure).
3) Disabling any Restraining Means (110a, 110b) that may restrict removal of said container from said CRM (this preferably may require the presentation of one at least User ID Means (150) to said CFM and/or CSM.
4) Inactivating said Indicator Means when said container is removed.
5) Returning said Restraining Means (110) to prevent insertion of said bottle.
6) Instructing (eg speaker and/or display) the quantity of said ingredient to add to the cocktail mix.
7) Requesting that said container be returned to its CRM (or an alternative).
8) Activating the Indicator Means on the destination CRM for said container to be returned, preferably using the correct colour and flash rate. This preferably may also involve the movement of said CRM.
9) Requiring presentation of a User ID Means.
10) Instructing the appropriate Restraining Means to allow acceptance of said container.
11) Detecting insertion of said bottle.
12) Instructing the appropriate Restraining Means to lock said container in the appropriate CRM.
13) Inactivate the appropriate Indicator Means.
14) Repeat one at least of steps 2 through 13 if there is a second mix in said cocktail available to the system, or advise (eg the user) that the mix is complete and/or any other instructions. Said other instructions preferably may include a required process, that is to be followed by the addition of further ingredients.

One at least CFM preferably may calculate the amount of alcohol in one at least cocktails consumed and/or to be consumed by one at least persons; and/or a cumulative log of alcohol consumed by one at least persons over one at least periods (eg the evening). One at least persons is preferably associated with alcohol consumption by their User ID Means. The invention preferably allows that one at least alcohol limits may be set for one at least persons. The invention preferably allows for one at least actions if one at least persons exceeds and/or attempts to exceed said limit. For example i) said person may be restricted from accessing additional alcohol, for one at least periods; and/or ii) an alarm may be triggered to ensure said person does not attempt to drive home (and/or that one at least other measures may be taken to protect their welfare).

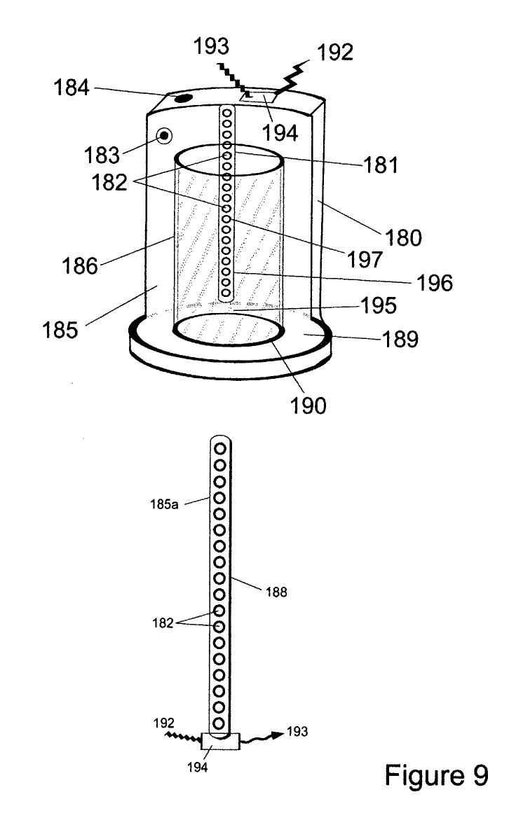

The invention preferably allows that one at least CFM may interface with one at least Fluid Level Indicator Means (FLIM) (185). An example of a FLIM is depicted in the top drawing of FIG. 9. This shows a Stand Means (180) that includes a Base Means (189), wherein said base preferably may support one at least containers (eg cocktail glasses, cocktail shakers). Said container is preferably placed on said Base Means (189) during part at least of the preparation of a cocktail. There is preferably one at least Container Positioning Means (190) (eg a raised rim) to assist positioning of one at least beverage containers. A Level Indicator (181) is shown mounted to said Stand Means (180) such that it is preferably positioned behind Beverage Container (186). For example, one at least Level Indicators (181) preferably includes a Variable Length Illumination Means (182) (eg. i) one at least lines of individually addressable LED's; and/or ii) one at least strips of Light Emitting Plastic; and/or iii) one at least strips of Organic Light Emitting Diodes (OLED's)).
For example, when a beverage container is empty, it is preferable that the Variable Length Illumination Means is turned off, and that in response to a cocktail mix, one at least CFM may direct said Variable Length Illumination Means (VLIM) to illuminate from the Bottom Location (195) to a First Location (196) representing the level that a First Cocktail Ingredient is to be poured. Said CFM preferably may then direct said VLIM to illuminate to a Second Location (197) representing the level that a Second Cocktail Ingredient is to be poured. This process preferably may be repeated until the necessary ingredients have been added.

It is preferable that plural colours may be generated by one at least VLIM and that the colour displayed may contrast with the colour of the cocktail mix (allowance is preferably made that said colour may change as different ingredients are added).

It is preferable that one at least CFM is coupled to a means that preferably includes a computer and computer program and/or information stored on computer readable media:—
i) to store the volume of one at least beverage containers,
ii) the shape of said container,
iii) means to determine the distance up said container one may need to fill, in order to pour one at least volumes and/or weight of ingredient(s). For example, a cylindrical glass may have a constant volume to height ratio, whilst a fluted glass may have different characteristics depending on the distance from the base.

The invention preferably allows that one at least FLIM's may include Automated Fluid Level Detector Means. For example, a Digital Imaging Means (183) may be used to monitor fluid levels. A second example embodiment of a FLIM (185a) is depicted in the bottom drawing of FIG. 9. In this example, the FLIM may be inserted inside the Beverage Container. A semiconductor fluid detector (188) preferably may be used as another example of an Automated Fluid Level Detector.

One at least FLIM's preferably include, as non-limiting examples, one at least of Control Electronics (194) (eg processor, memory storage means), Power Means (eg battery), Interface Means (eg Wireless (192) and/or Wired (193)). One at least CFM preferably may interface with one at least FLIM's.

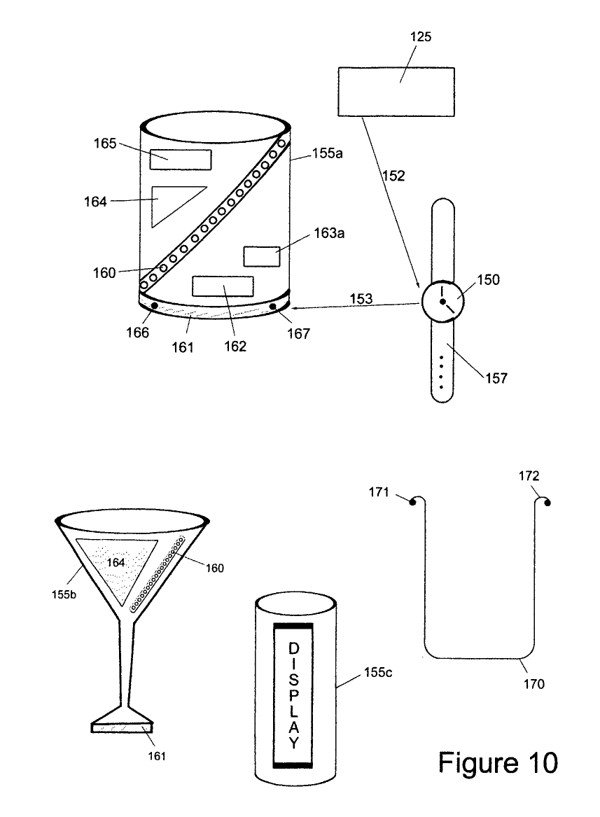

The invention is now described with reference to FIG. 10 of the drawings. The invention preferably allows that as a non-limiting example, part at least of means described for a CFM and/or part at least of means described for a FLIM may be integrated into an Intelligent Beverage Container (155). As a non-limiting example, one at least display means preferably may be incorporated into and/or attached to one at least parts of said Intelligent Beverage Container. The preferred method is to include one at least display means in the wall of said container. For example, one at least display means (160) preferably may perform the functions of a Variable Length Illumination Means (182, FIG. 10). One at least display means preferably may display the Cocktail Name (165); and/or cocktail ingredients and/or cocktail mixing instructions (164); and/or the name of the current user (162) of said container; and/or the alcohol content of the present beverage (163a) and/or the cumulative amount of alcohol (163b) consumed by one at least persons in one at last periods of time.

The following non-limiting examples of display means are not depicted in the drawing:—

One at least display means preferably may display one at least of:—
the temperature of the contents of said container.
a plurality of colours.
moving images.
one at least advertisements.
the results of one at least games of chance (eg keno).
bets placed by one at least persons.
the results of one at least sporting games.
cooking recipes.

One at least Intelligent Beverage Container (155) preferably may include user interface means (eg keyboard (eg on underside of container and/or touch panel on wall of container), microphone (167), speaker means (166), menu selection from one at least display means); and/or power means (eg battery)

One at least Intelligent Beverage Container (155) preferably may include a means to facilitate one at least display means, displaying one at least colours that contrasts with the contents (eg cocktail) of said container.

One at least Intelligent Beverage Container (155) preferably may include wireless means (eg zigbee, bluetooth) to interface with remote means (eg CSM Control Means).

One at least Intelligent Beverage Container (155) preferably may include secure processing means. For example, this may enable one at least persons to place an encrypted bet (eg keno) with one at least remote means; and/or receive a coded verification that they are a winner and/or their winnings. For example, presentation of said Intelligent Beverage Means at one at least cashier means may enable said person to obtain a cash payout for their winnings. One at least Intelligent Beverage Container preferably may securely store one at least electronic fund means that, for example, may be used to purchase goods and/or services, and/or to place one at least bets.

One at least Intelligent Beverage Container (155) preferably may enable one at least persons to place an order for one at least beverages and/or meals via wireless means. For example, one at least Intelligent Beverage Containers may be used by one at least persons to send a wireless order to the bar for a known cocktail mix and/or to describe a custom cocktail mix for delivery (said customisation preferably prepared using said Intelligent Beverage Container). Information sent to a remote means preferably identifies the location (eg table number) of the customer.

A first Intelligent Beverage Container preferably may come in a first shape and/or size (155a) and one at least second Intelligent Beverage Containers preferably may come in one at least second shapes and/or sizes (155b, 155c).

The invention preferably allows that one at least Intelligent Beverage Container preferably may be fitted with an Internal Sleeve Means (170). Said Internal Sleeve Means is preferably Moulded (172) to fit over the rim of one at least Intelligent Beverage Containers. There is preferably a Sleeve Retaining Means (171) (eg plastic snap-lock fitting) to facilitate coupling (preferably reversibly) of said Internal Sleeve Means (172) with said Intelligent Beverage Container (155). For example, one at least Intelligent Beverage Container fitted with an Internal Sleeve Means (170) preferably may be used as a cocktail preparation means (eg shaker), and said Internal Sleeve Means removed with said cocktail and inserted into a second container means (eg Intelligent Beverage Container and/or known art container). In another example, one at least Intelligent Beverage Containers equipped with said Internal Sleeve Means (170) preferably may be used to both mix and then consume said cocktail, and said Internal Sleeve Means (170) preferably discarded and replaced prior to preparing a new cocktail. One at least Intelligent Beverage Container preferably may be used to prepare a cocktail in the absence of said Internal Sleeve Means and the resultant cocktail preferably may be consumed directly from said Intelligent Beverage Container and/or poured into a second container means (eg Intelligent Beverage Container and/or known art container).

The invention preferably allows for one at least User ID Means (150) (eg RFID Transponder) that as a non-limiting example, preferably may be attached to the wrist by a strap (151). said User ID Means preferably may interface with one at least Intelligent Beverage Containers, and/or CFM's, and/or means coupled to one at least CSM.

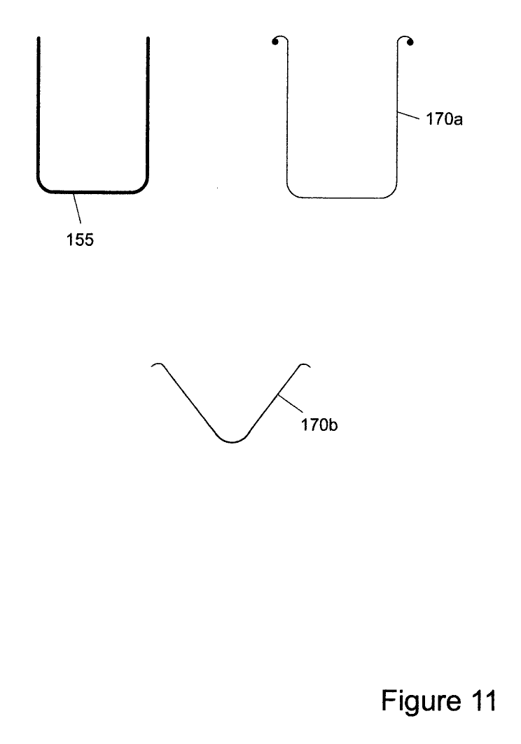

Reference is now made to FIG. 11 of the drawings. The invention preferably allows that one at least Intelligent Beverage Means (155) may have its internal shape and/or size modified by the use of a First Internal Sleeve Means (170a) for a first shape and/or size, and one at least Second Internal Sleeve Means (170b) for one at least second shape and/or sizes.

The invention preferably allows that one at least Cocktail Formulating Means and/or Intelligent Container Means preferably may be used in conjunction with other means described for the invention (eg automated selection of one at least ingredients from one at least CRM's). For example, a person may request a particular cocktail, and said CFM preferably may:—
direct them to a first ingredient using automated means;
uses Variable Length Illumination Means to indicate the amount of said ingredient to pour into the beverage container;
direct them to a second ingredient using automated means;
uses Variable Length Illumination Means to indicate the amount of said second ingredient to pour into the beverage container;
   preferably continuing the process until said cocktail is prepared.

The invention preferably allows for one at least public drinking places (eg restaurant, bar, pub, cocktail lounge) to be equipped with one at least CSM that store a plurality of cocktail mixes, wherein a plurality of user may be provided with Intelligent Beverage Containers. One at least bar persons may be used to prepare one at least cocktails (and/or other beverages). One at least users preferably may have access to a cocktail smorgasbord arrangement wherein they may prepare their own cocktails.

The usage of one at least persons preferably may be monitored and said usage preferably may determine the amount one at least person pays for their drinks. In another embodiment one at least persons may pay a flat rate for access to cocktail ingredients for a preferably predetermined period and/or amount of alcohol. In another embodiment one at least persons may pay a first flat rate for access to a first range of cocktail ingredients for a preferably predetermined period and/or amount of alcohol, and a second flat rate for access to a second range of cocktail ingredients for a preferably predetermined period and/or amount of alcohol. One at least User ID Means preferably may be used to facilitate regulation of various ingredient access programs.

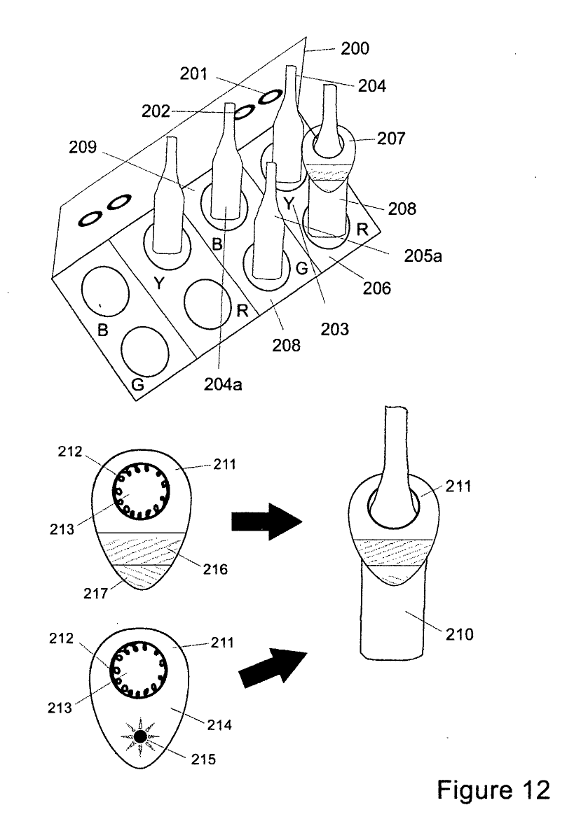

FIG. 12 of the drawings discloses further embodiments for the use of electrically operable indicators in conjunction with beverage storage containers. A shelf arrangement 200 preferably supports one at least beverage containers (eg bottle 204, 205,204a, 205a). The shelf is preferably differentially coloured, eg red area 206, yellow area 203, green area 208, blue area 209. A first bottle 204 is preferably associated with a first coloured area 203, a second bottle 205 with a second coloured area 206, etc. it is preferable that said beverage storage container are coupled to electrically operable ID's as disclosed elsewhere in this specification. The shelf preferably include a means to read said ID's. An electrically operable indicator 202 is preferably provided that may illuminate in a plurality of colours eg. if yellow the bottle 204 at yellow location 203 is preferably the target bottle, if red illuminates, the target is preferably bottle 205 on the red area 206. Indicator 201 is preferably used to handle plural accesses and/or customers concurrently (eg customer 1 may recognise a pink indicator has their cue and then select the bottle using container indicator 202). It is preferable that coloured areas may be multicoloured and one or more indicator used to produce plural colours concurrently. As an enhancement and/or an alternative to the coloured storage areas, it is preferable that one at least beverage storage containers may be colour coded with a coding apparatus that is preferably reversibly attachable. The apparatus 211 is constructed of plastic for example. It preferably includes a means to attached to a beverage storage container, eg using hole 213. There is preferably a means to retain said coding apparatus in place when the container is tipped to pour the contents, for example flexible insert (eg rubber and/or plastic) 212 preferably causes friction reducing the opportunity for said coding apparatus to slip over the neck of the bottle. The coding apparatus of the present example preferably attaches by sliding it over the neck of the bottle 210. The coding apparatus preferably has one at least coloured areas 216, 217, that distinguish it from one at least other coding apparatus. It is preferable that the bottle indicator may be remote to said storage location. For example on a beverage preparation facilitator device. It is preferable that a portable electrically operable indicator 214 may be provided that preferably attaches to one at least beverage storage containers. This preferably may or may not have additional colour and/or indicia coding. It is preferable that indicia representing the name of the beverage that said visual indicator 211 and/or electrical indicator 214 is visible on a surface of said indicators. The portable electrically illuminable indicator 214 preferably includes an electrically illuminable device 215, and not shown:—
a computer, computer memory, computer program in said memory, information stored in said computer memory, a battery and/or capacitor, and/or solar cell, and/or other power source, a device to receive and/or send information by wireless, and an electrically readable ID to facilitate differentiation of said indicator from one at least other indicators.

The invention preferably allows for a means to obtain information pertaining to one at least beverage and/or food storage containers and/or the contents of said containers, without disturbing said containers. For example, a wine cellar may have a large number of bottles that should be left undisturbed wherever possible. The means described for the present invention allow information coupled to said storage container (eg wine bottle) to be read without disturbing said container. Means are also described for storing information pertaining to said container in an electronic database. For example, a person may cause the electrically operable indicator associated with a particular container that they require information about to change state (eg light up). For example they may use a portable electronic device to send a signal that operates said indicator, eg a simple four way arrow key may be used to sequentially operate one at least indicators in the horizontal and vertical direction until the desired indicator illuminates. The person preferably provides a confirm command that directs a computer coupled to said database to provide the required information for the beverage storage container associated with said electrically operable indicator. A variation on this theme preferably may be applied to supermarket items to enable the consumer to obtain the price of a particular item on a shelf, for example.

One at least beverage containers preferably may be edible. It is preferable that an edible beverage container includes an opening to add beverages. It is preferable that there is a means to close said opening, for example, a portion of chocolate and/or edible substance, that for example, plugs into said hole, adheres to said opening, covers said opening. The means of the invention pertaining to beverages preferably may be applied in part at least to one at least fillings (eg chocolate soft centre) added to said edible container. The invention preferably allows for the manufacture and/or supply of an edible beverage container that is for use with part at least of the means of the invention disclosed in this specification. The invention preferably allows for a chocolate with an opening, said chocolate able to receive one at least edible substances after provision of said chocolate to a consumer. The invention preferably allows for the tagging of one at least chocolates with an electrically readable ID, for example the bottom of one at least chocolate wrappers (that are traditionally brown, for example) preferably includes one at least shapes and/or colours that may be used to distinguish said chocolate from one at least other chocolates. Said shapes and/or colours are preferable on a light background. The invention preferably allows for a plurality of chocolates to be provided in an enclosure (eg chocolate box) that is coupled to a power source and at least a first electrically operable indicator associated with a first chocolate and a second electrically operable indicator associated with said second chocolate. The means of the invention preferably may be applied to facilitate selection of a first chocolate in preference to a second chocolate (eg a voice command requesting a chocolate with a strawberry centre preferably activates the indicator associated with said strawberry centred chocolate).

It is preferable that an edible beverage container includes an opening to add beverages. It is preferable that there is a means to close said opening, for example, a portion of chocolate and/or edible substance, that for example, plugs into said hole, adheres to said opening, covers said opening. The means of the invention pertaining to beverages preferably may be applied in part at least to one at least fillings (eg chocolate soft centre) added to said edible container. The invention preferably allows for the manufacture and/or supply of an edible beverage container that is for use with part at least of the means of the invention disclosed in this specification. The invention preferably allows for a chocolate with an opening, said chocolate able to receive one at least edible substances after provision of said chocolate to a consumer. The invention preferably allows for the tagging of one at least chocolates with an electrically readable ID, for example the bottom of one at least chocolate wrappers (that are traditionally brown, for example) preferably includes one at least shapes and/or colours that may be used to distinguish said chocolate from one at least other chocolates. Said shapes and/or colours are preferable on a light background. The invention preferably allows for a plurality of chocolates to be provided in an enclosure (eg chocolate box) that is coupled to a power source and at least a first electrically operable indicator associated with a first chocolate and a second electrically operable indicator associated with said second chocolate. The means of the invention preferably may be applied to facilitate selection of a first chocolate in preference to a second chocolate (eg a voice command requesting a chocolate with a strawberry centre preferably activates the indicator associated with said strawberry centred chocolate). The invention preferably allows for one at least means described to couple an electrically operable display to a beverage container to be applied to a chocolate box, for example a cut out and/or clear window in said box preferably exposes a display stored inside. A non-limiting use of said display preferably includes providing an electronic greeting card, preferably with sound. A similar greeting application preferably may be applied to a beverage container. The chocolate box preferably may include a mans (eg piezo switch, mechanical switch) to detect opening of said box, said opening preferably triggering one at least events. The display means for said chocolate box preferably may be applied too other containers. The use of internal electrically operable displays and/or display fabricated into the wall of a container is preferably not limited to food and beverage containers, for example it may be used to enhance a CD or DVD package.

The appended Claims, being Claims 1 through 226 include information not disclosed in this specification. Said Claims information when read in conjunction with this specification should enable those experienced in the art to implement further embodiments of the present invention. Said Two Hundred and Fifty Six Claims (1 through 256) are incorporated into this specification by way of reference.

It is understood that variations in the figures or described elsewhere in this specification are for illustrative purposes only and that many other variations will be apparent to one skilled in the art. It will also be understood that the specification and figures are illustrative of the present invention and that other embodiments within the spirit and scope of the invention will suggest themselves to those skilled in the art.

1-226. (canceled)

227. An electrically operable system for use with plural containers of alcoholic beverage said container preferably a bottle, the system comprising:—
a) at least first and second storage locations each arranged to store at least one said container; and
b) a first output signal user associable with the first storage location preferentially to the second storage location, said first output signal facilitating user interaction with the first storage location and said first output signal electronically switchable between an inactive state and at least one active state; and
c) a second output signal user associable with the second storage location preferentially to the first storage location, said second output signal facilitating user interaction with the second storage location and said second output signal electronically switchable between an inactive state and at least one active state; and
d) computer accessible memory arranged to store information pertaining to at least one beverage container and or beverage container contents, the stored information preferably usable by a computer in facilitating automated operation of one at least output signals;
the system further arranged for activating and or inactivating the:
first output signal preferentially to the second output signal, and or second output signal preferentially to the first output signal and or first and second output signal concurrently.

228. The electrically operable system of claim 227 wherein the plural containers of alcoholic beverage comprise bottles of wine and said storage locations are arranged as a wine cellar.

229. The electrically operable system of claim 227 wherein the plural containers of alcoholic beverage comprise bottles of alcoholic mixer drinks for use in preparing an alcoholic cocktail,
and
a first bottle is stored at the first storage location and or a second bottle is stored at the second storage location,
and
activation of the first and or second output signal is a response to computer access to computer readable memory storing information related to said alcoholic cocktail.

230. The electrically operable system of claim 227 further arranged to be responsive to voice.

231. The electrically operable system of claim 227 further arranged to access a real time clock and preferably to store information pertaining to one at least of the time a container is:—i) placed in and or removed from the first storage means, ii) rotated around its long axis.

232. The electrically operable system of claim 227 wherein the computer accessible memory is further arranged to store information facilitating electronic addressing of at least one of: an electrically operable indicator switchable to provide an output signal, storage location vacancy determination device, storage location access restriction device, storage location electronic thermometer, or storage location temperature control.

233. The electrically operable system of claim 227 wherein the computer accessible memory is further arranged to stored information pertaining to at least one of: storage location output signal status, number of containers present in a storage location, storage location access restriction device status, time of placement of a container in a storage location, time of removal of the container from a storage location, bar code of a container stored in a storage location, electronic ID of a device attached to a container stored in a storage location, rotation about long axis of container stored in a storage location, parameter of a container stored in a storage location, parameter of the contents of a container stored in a storage location, the ID of a user interacting with a storage location, the weight of a container stored in a storage location.

234. The electrically operable system as claimed in claim 227 wherein the first and or second output signals comprise a visible signal, preferably produced by an electrically illuminable source.

235. The electrically operable system of claim 234 wherein the activated output signal comprises visible light:
i) emitted from the associated storage location and or
ii) arranged to illuminate part at least of the opening of and or area surrounding the opening of the associated storage location preferentially to the opening and or area surrounding the opening of at least one other storage location.

236. The electrically operable system of claim 227 wherein the user interaction associated with the first and or second activated output signal comprises selection of a container for removal from the storage location associated with said output signal.

237. The electrically operable system of claim 227 wherein the containers of alcoholic beverage comprise bottles of wine and the user interaction associated with the first output signal comprises one at least of: identifying the first storage location as a destination to place a bottle of wine, identification of the first storage location as storing a bottle of wine due for rotation of the bottle around its long axis, identifying the first storage location as populated with a bottle of wine for removal from said location and transfer to the second storage location, identifying the first storage location as a destination for a bottle of wine for transfer from the second storage location, the system preferably further arranged to activate the second output signal associated with said second storage location when the second location is the subject of a transfer operation with the first location.

238. The electrically operable system as claimed in claim 227 wherein the first and second output signal are activated and the storage locations associated with the first and second concurrently activated output signal: store and or are a target for storage of a bottle of wine with a shared characteristic, the shared characteristic preferably selected from at least one of wine variety, red wine, white wine, producer, vintage.

239. The electrically operable system of claim 227 wherein activation of an output signal associated with the first and or second storage location is a response to the electronic identification of a container of alcoholic beverage for storage in the first and or second storage location, said identification preferably comprising reading an electrically operable ID attached to the container, and or a bar code attached to the container and or image processing of a label attached to the container.

240. The electrically operable system of claim 227, wherein the first and second storage locations are arranged to store only one bottle of wine each.

241. The electrically operable system of claim 227 further comprising at least one of: modular expansion of container storage means, container storage control means, container information library, container information edit means, module spatial arrangement means, spatial receptacle library, receptacle constraints library, bottle usage constraints library, container receptacle graphical representation means, container occupancy detection means, receptacle stocking facilitation means, insertion initialization means, bar code input means, product constraint means, product information update means, image capture input means, data entry means, receptacle selection means, and or bottle rotation constraints.

242. The electrically operable system of claim 227 further comprising one at least of: stored container localization means, no bottle found means, parameter modification means, plural resolution means, container receptacle cleanup means, error reporting means, and or section indicator means.

243. The electrically operable system of claim 227 wherein the first and or second output signal comprises a first active state at a first time and a second active state at a second time, said first and second states distinctive to each other, wherein said distinction is preferably by at least one of color, color combination, intensity or pulsing.

244. The electrically operable system of claim 243 wherein: the first state is directed to a first person and or associated with a first function, and or the second state is directed to a second person and or a second function.

245. The electrically operable system of claim 227 wherein user access to remove a stored container from and or to place a container to a storage location is restricted by an electrically operable barrier and preferably wherein said barrier is opened in response electrically readable information provided by an authorized user.

246. The electrically operable system of claim 227 wherein:
the first output signal is provided by an electrically controlled visible indicator that is preferably electrically illuminable;
and
said indicator is associated by way of attachment to the first container;
and
said indicator is electronically addressable at a first address,
and
said indicator is wired to a power source;
and preferably wherein:
the container, indicator and power source comprise a portable unit.

247. The electrically operable system as claimed in claim 246 wherein:
the second output signal is provided by an electrically controlled visible indicator that is preferably electrically illuminable;
and
said indicator is associated by way of attachment to the second container;
and
said indicator is electronically addressable at a second address distinct to said first address, and
said indicator is wired to a power source;
and preferably wherein:
the container, indicator and power source comprise a portable unit;
and
said first and second indicators are for use in a shared environment whereby said first indicator is controlled by use of said first address and said second indicator is controlled by use of said second address.

248. The electrically operable system as claimed in claim 247 wherein said first and second indicator are controlled by a wireless signal sent from a computer, preferably a portable computer.

249. The electrically operable system as claimed in claim 247 wherein the first and or second container are further attached to electrically readable content transferable to a computer by wire and or wireless.

250. The electrically operable system as claimed in claim 227 wherein:
the first active output signal includes color content related information of a first color and the second active output signal includes color content related information of a second color distinct to the first color,
and
said first container is proximal to a first colored area preferentially to a second colored area,
and
said second container is proximal to the second colored area preferentially to the first colored area,
wherein
the first color is for comparison with the color of the first colored area and said association of the first output signal with the first container comprises the first color visually resembling the color of the first colored area more closely than the second color resembles the first colored area,
and
the second color is for comparison with the color of the second colored area and said association of the second output signal with the second container comprises the second color visually resembling the color of the second colored area more closely than the first color resembles the second colored area.

251. The electrically operable system as claimed in claim 250 wherein:
the first colored area:
comprises part of said first storage location,
and or
is attached to the first container;
and
the second colored area:
comprises part of said second storage location,
and or
is attached to the second container;
and preferably wherein said first color content related information comprises visible light of said first color and or the second color content related information comprises visible light of said second color.

252. The electrically operable system as claimed in claim 250 wherein said first and second output signals are provided by the same device outputting:
a first color when operational to provide the first output signal,
and
a second color when operational to provide the second output signal, and preferably wherein said device comprises a multicolored electrically illuminable device selectively operable to output at least two distinct colours.

253. The electrically operable system as claimed in claim 227 further comprising a first electrically operable container ID reader arranged to read identifying information from a first container stored in the first storage area and or a second electrically operable container ID reader arranged to read identifying information from a second container stored in the second storage area wherein:
the information read by the first ID reader facilitates activation and or inactivation of the first output signal,
and or
the information read by the second ID reader facilitates activation and or inactivation of the second output signal,
and preferably wherein the reader for reading the first container identifying information is distinct to the reader for reading the second container identifying information.

254. The electrically operable system as claimed in claim 253 wherein:
the identifying information is obtained from an electrically operable device attached to the container,
and said attached device stores identifying content,
and preferably
the attached device includes an RFID transponder and or a device that transfers power and data over a single electrical conductor.

255. The electrically operable system as claimed in claim 227 further comprising at least one bottle of alcoholic beverage for storage by the system wherein an electronically operable ID device is attached to said bottle and said ID device is readable by the system.

256. An electrically operable system for storing a plurality of beverage containers, wherein the system electronically facilitates one at least of beverage container placement to, rearrangement within, and or selection for retrieval from the system, the system further comprising at least first and second beverage container storage locations,
and
a first electrically operable container ID reader is associable with the first beverage container storage location and the first reader is for reading identifying information from a beverage container stored in the first beverage container storage location,
and
a second electrically operable container ID reader is associable with the second beverage container storage location and the second reader is for reading identifying information from a beverage container stored in the second beverage container storage location,
and
preferably wherein the first beverage container storage location is arranged to store a single beverage container and the second beverage container storage location is arranged to store a single beverage container.

257. An electrically operable system for storing a plurality of beverage containers as claimed in claim 256 wherein the beverage containers comprise bottles of wine and the container storage locations comprise a wine cellar arrangement.

258. An electrically operable system for storing a plurality of beverage containers as claimed in claim 256 wherein the system further comprises a first electrically illuminable indicator associated with the first beverage container storage location and a second electrically illuminable indicator associated with the second beverage container storage location,
and
operation of the first indicator is facilitated by the first reader and operation of the second indicator is facilitated by the second reader.

259. An electrically operable ID device for attachment to and or attached to a container of alcoholic beverage, preferably wherein the container comprises a bottle.

260. An electrically operable ID device as claimed in claim 259 wherein the ID device is reversibly attachable to the container.

261. An electrically operable ID device as claimed in claim 259 comprising:
RFID device; and or
device that transfers power and data over a single conductor; and or a portable device comprising a power source and an electrically illuminable indicator selectively operable by wireless commands.

262. A portable container for storing a plurality of pieces of confectionery, the container comprising at least one electrically operable device, preferably wherein said confectionery comprises chocolates.

263. A system for preparing a mixed beverage from a plurality of distinct ingredients, said ingredients preferably including at least one alcoholic beverage, wherein the system comprises an electronically controlled output signal arranged to provide a person with information related to the amount of at least one ingredient to add during said preparation.

264. A system for preparing a mixed beverage as claimed in claim 263 wherein the system is further arranged to facilitate activation of at least one electrically controlled indicator associable with a container storing said distinct ingredient, said association preferably by way of proximity to the container and or attachment to the container.

265. A system for preparing a mixed beverage as claimed in claim 264 wherein the output signal comprises a visible signal:
with a computer determined position relative to the container,
and or
associable with a level related to the container and or the container contents.

266. An electrically operable device for use with a portable container arranged to receive a consumable ingredient, said ingredient preferably including a beverage, wherein said device is:
responsive to information related to the amount of ingredient for adding to the container,
and
arranged to activate a visible and or audible output signal related to a level to which to add said ingredient in the container;
and preferably wherein the output signal includes one at least of electronically controlled:
i) sound and or visual signal activated in response to a weight of ingredient added to the container;
ii) sound and or visual signal activated in response to a pressure exerted by a fluid in the container;
iii) sound and or visual signal activated in response to an automatically detected level of ingredient in the container;
iv) visible indicator located within the container;
v) visible indicator attached to or embedded in the wall of the container;
vi) visible indicator proximal to the outside of the container preferably arranged to be viewable through the wall of the container.

267. A system comprising a computer and an electrically operable display attached to or arranged for attachment to a beverage drinking container, preferably wherein the container includes a glass, mug or cup.

268. A system comprising a computer and an electrically operable display of claim 267 further comprising one at least of:
a visible output signal facilitating preparation of a mixed alcoholic drink;
electronically output information related to a cocktail, and or cocktail ingredients and or cocktail mixing instructions;
electronically output identifying information related to the consumer of a beverage in said container, and or the cumulative amount of alcohol consumed by said consumer, and or the alcohol content of a beverage presently stored in the container;
temperature of a beverage stored in the container;
electronically generated advertisement;
electronically output result of a game of chance and or sporting game;
an arrangement to electronically place a bet and or receive winnings;
secure processing;
an arrangement to electronically place an order for a beverage and or meal.
